(19) United States
(12) Patent Application Publication
(10) Pub. No.: US 2007/0016389 A1
(43) Pub. Date: Jan. 18, 2007

(54) Method and system for accelerating and improving the history matching of a reservoir simulation model

(76) Inventor: Cetin Ozgen, Centennial, CO (US)

Correspondence Address: SHERIDAN ROSS PC, 1560 BROADWAY, SUITE 1200, DENVER, CO, 80202, US

(21) Appl. No.: 11/344,751

(22) Filed: Jan. 31, 2006

Related U.S. Application Data
(60) Provisional application No. 60/693,765, filed on Jun. 24, 2005.

(51) Int. Cl. G06G 7/48

(52) U.S. Cl. 703/10

(57) ABSTRACT

The present invention, in one embodiment, is directed to a method and system for accelerating and improving the history matching of a well bore and/or reservoir simulation model using a neural network. The neural network provides a correlation between the calculated history match error and a selected set of parameters that characterize the well bore and/or the reservoir. The neural network iteratively varies a selection and/or the value of the parameters to provide at least one set of history match parameters having a value that provides a minimum for the calculated history matching error.

The present application claims priority to U.S. Provisional Application No. 60/693,765, filed Jun. 24, 2005, the entirety of which is incorporated by reference.

### BACKGROUND OF THE INVENTION

a. Field of the Invention

The present invention relates to, in one embodiment, a method and system for determining and graphically displaying a history matching error between historical well bore and/or reservoir data and simulated data. In another embodiment, the present invention relates to a method and system for accelerating and improving the history matching of a reservoir simulation model.

b. Background Art

It is well known that crude oil, natural gas, and water flows through porous and permeable rock beneath the earth's surface and is trapped in hydrocarbon “reservoirs.” Each crude oil, natural gas, and water reservoir has its own unique characteristics which affect how successfully the reservoir may be produced and exploited. Fully characterizing and understanding a reservoir is critical to drilling wells at appropriate locations and assessing the risk or likelihood of success of drilling in a particular location or of maintaining an optimal output from the reservoir, through well known production techniques and the utilization of enhanced production techniques including artificial lift, hydraulic fracturing, water flooding, gas injection, etc.

The characterization of hydrocarbon reservoirs changes over time, and is a dynamic process. For instance, as a reservoir loses pressure, the natural crude oil and natural gas production rates decline. To ensure appropriate steps are taken to optimize fluid extraction, a reservoir's wells, and the entire reservoir field must be constantly monitored. To do so, reservoir simulation software is known to utilize and evaluate current production characteristics of reservoirs and individual wells in order to predict the future performance using such parameters as multiphase fluid flow, compositional component tracking in liquid and gas phases, fluid-rock interactions, the porous and permeable nature of natural underground reservoirs, and the areal and vertical lithologic changes in the nature of the rocks, as well as production rate and pressure-time plots, i.e., pressure decline data.

Computer reservoir simulators are one of these best technologies utilized in the petroleum and hydrology industries to understand and predict a reservoir's future performance (production and pressure) under proposed development scenarios (well spacing, gas injection, water flooding, miscible displacement, steam injections, etc.). Known simulation software utilizes actual historical production rate and pressure-time data for each well as a basis for simulating both historical and future performance for the wells and/or reservoir. Results are often not in a readily understandable form for quick and thorough analysis due to large model sizes (number of cells and layers), large numbers of wells and extensive timeframes being simulated.

Moreover, the premise of reservoir simulation is that future performance can be predicted reliably with the simulator if the past performance of the reservoir can be “reproduced” by the simulator. Reproducing the past performance is referred to as “history matching.” The previously noted uncertainty in some or many of the variables needed to describe a reservoir in the simulator often renders history matching a very difficult process. For example, the user will perform a simulation run and thereafter manually modify one or more variables, and run the simulation model. This iterative process will be repeated until the user “guesses” the right combination of variables and associated values. Accordingly, known methods are notably time-consuming, inefficient, and do not provide one or more fully optimized solutions. Thus, there is a need for a faster, more reliable method of improving the history matching process.

### SUMMARY OF THE INVENTION

In one aspect of the present invention, there is provided a method and software system for utilizing data and associated analysis of history matching error to improve the predicted recovery of reservoir fluids, which provides a readily understandable synopsis for the fluid reservoir, and which uses history matching error to produce faster, more reliable pressure and production rate predictions for individual wells and/or the reservoir in its entirety. In particular, the present invention includes an interactive “history matching” process to reproduce the historical production and pressure performance of a reservoir in order to reliably predict its future performance. The more historical data that is provided for history matching, the more reliable the “simulation model” of the present invention will be, which serves as a basis for history matching error determination and the reliability of future performance predictions. As a result, the present invention significantly streamlines and accelerates prior known reservoir simulation history matching processes.

In accordance with one aspect of the invention, there is provided a method for predicting the recovery of fluids from a reservoir using a computer comprising:

a) receiving historical performance data for an individual well bore and/or a reservoir;

b) constructing a theoretical production output model for the well bore and/or reservoir using the received data;

c) calculating a history matching error between the theoretical production output model and the historical production output data for said well bore and/or reservoir;

d) if the calculated value of said history matching error is different from a predetermined value, modifying a parameter of the received data and redoing steps (b) and (c); and

e) displaying said calculated history matching error as a graphical representation in at least one of a plot and a map;

f) predicting a future production output for said at least one of a well bore and a reservoir when the calculated value of the history matching error is equal to or less than the predetermined value.

The present invention further includes a software system for carrying out the above method.

In accordance with another aspect of the present invention, there is provided a method for visually displaying the calculated history matching error. The visual display enables the user to readily see the portions of the well bore and/or reservoir where there is a substantial discrepancy between the historical performance data and the simulated performance model data.

In accordance with yet another aspect of the present invention, there is provided a method for providing an improved (history matched) reservoir simulation model, comprising:

a) receiving data for an individual well bore and/or a reservoir;

b) constructing a theoretical production output model for said well bore and/or reservoir using said received data;

c) calculating a history matching error between said theoretical production output model and said historical production output data for said well bore and/or reservoir;

d) receiving a plurality of reservoir parameters corresponding to a property of said well bore and/or reservoir.

e) using a neural network to provide a correlation between a selected set of said reservoir parameters and said history matching error;

f) iteratively varying at least one of a selection and a value of said reservoir parameters in the neural network to provide at least one set of reservoir parameters having a value(s) that provides a minimum for said history matching error.

The present invention further includes a software system for carrying out the above method.

### BRIEF DESCRIPTION OF THE DRAWINGS

FIG. 1 depicts a conventional graphical representation of the fit between simulated water, gas, and oil production rates to actual water, gas, and oil production rates for a total reservoir system in accordance with the present invention;

FIG. 2 depicts a conventional graphical representation of the fit between simulated pressure, water, gas, and oil production rates to actual pressure, water, gas, and oil production rates for a well string in accordance with the present invention;

FIG. 3 depicts a conventional graphical representation of multiple cases of simulated water, gas, and oil production rates to actual water, gas, and oil production rates for a total reservoir system in accordance with the present invention;

FIG. 4 depicts a conventional graphical representation of multiple cases of simulated pressure, water, gas, and oil production rates to actual water, gas, and pressure, oil production rates for a single well in accordance with the present invention;

FIG. 5 depicts a conventional graphical representation of history matching error determinations for multiple simulated cases for pressure, water, gas, and oil rates for a total reservoir field in accordance with the present invention;

FIG. 6 depicts the unique graphical representation of HM error determinations for multiple simulated cases for pressure, water, gas, and oil rates for a well string in accordance with the present invention;

FIG. 7 depicts the unique krigged color-banded HM error map for pressure for a total field in accordance with the present invention;

FIG. 8 depicts the unique krigged color-banded HM error map for the water production rate of a total field in accordance with the present invention;

FIG. 9 depicts the unique krigged color-banded HM error map for the gas production rate of a total field in accordance with the present invention;

FIG. 10 depicts the unique krigged color-banded HM error map for the water production rate of a reservoir for a specified one-year time period in accordance with the present invention;

FIG. 11 is a flowchart of the HM mismatch quantification and display process of the software system and method of the present invention;

FIG. 12 is a flowchart of the history matching process in accordance with the present invention.

FIG. 13 is a flowchart of the process for accelerating and improving history matching of a reservoir in accordance with one embodiment of the present invention;

FIG. 14 is a flowchart of the process for accelerating and improving history matching of a reservoir in accordance with another embodiment of the present invention;

FIG. 15 depicts a pull-down menu for defining history matching cases in accordance with one embodiment of the present invention;

FIG. 16 depicts a plurality of a listing of defined cases in accordance with one embodiment of the present invention;

FIG. 17 depicts a pull-down menu for defining history matching parameters in accordance with one embodiment of the present invention;

FIG. 18 depicts a window containing history matching parameters in accordance with one embodiment of the present invention;

FIG. 19 depicts a pull-down menu for assigning history matching weights for pressure data in accordance with one embodiment of the present invention;

FIG. 20 depicts a window containing history matching weights for pressure data in accordance with one embodiment of the present invention;

FIG. 21 depicts a pull-down menu for assigning history matching weights for rate data in accordance with one embodiment of the present invention;

FIG. 22 depicts a window containing history matching weights for rate data in accordance with one embodiment of the present invention;

FIG. 23 depicts a pull-down menu for defining history match runs in accordance with one embodiment of the present invention;

FIG. 24 depicts a window containing history match parameters in accordance with one embodiment of the present invention;

FIG. 25 depicts a pull-down menu for creating history matching runs in accordance with one embodiment of the present invention;

FIG. 26 depicts a window containing history matching parameters to be selected for perturbation in accordance with one aspect of the present invention;

FIG. 27 depicts a generated history match run in accordance with one aspect of the present invention;

FIG. 28 depicts a pull-down menu for loading simulation results in accordance with one embodiment of the present invention;

FIG. 29 depicts a window containing a loaded simulation result in accordance with one aspect of the present invention;

FIG. 30 depicts a pull-down menu for updating mismatch values in accordance with one embodiment of the present invention;

FIG. 31 depicts a window containing updated mismatch values in accordance with one aspect of the present invention;

FIG. 32 depicts a pull-down menu for generating mismatch maps in accordance with one embodiment of the present invention;

FIG. 33 depicts a map enabling the user to view simulation mismatch results in accordance with one aspect of the present invention;

FIG. 34 depicts a pull-down menu for generating mismatch plots in accordance with one embodiment of the present invention;

FIG. 35 depicts a mismatch plot enabling the user to view the progression of the HM error for various simulation cases in accordance with one aspect of the present invention;

FIG. 36 depicts a pull-down menu for developing a correlation model using a neural network in accordance with one embodiment of the present invention;

FIG. 37 depicts a window for developing a correlation model having selectable cases and history matching parameters in accordance with one aspect of the present invention;

FIG. 38 depicts a pull-down menu for generating a 2-D correlation plot in accordance with one embodiment of the present invention;

FIG. 39 depicts a 2-D correlation plot in accordance with one embodiment of the present invention;

FIG. 40 depicts a pull-down menu for generating a 3-D correlation plot in accordance with one embodiment of the present invention;

FIG. 41 depicts a 3-D correlation plot in accordance with one embodiment of the present invention;

FIG. 42 depicts a pull-down menu for defining an objective function in accordance with one embodiment of the present invention;

FIG. 43 depicts a window for the user to define parameters associated with an objective function in accordance with one embodiment of the present invention;

FIG. 44 depicts a pull-down menu for determining a subdomain for a history matching parameter in accordance with one embodiment of the present invention;

FIG. 45 depicts a histogram of a HM parameter in accordance with one embodiment of the present invention;

FIG. 46 depicts a histogram for the history matching parameter FWL with a reduced subdomain in accordance with one embodiment of the present invention;

FIG. 47 depicts a window for the clustering of multiple solutions in accordance with one embodiment of the present invention;

FIG. 48 depicts a window showing one clustered solution of five calculated clusters in accordance with one embodiment of the present invention;

FIG. 49 depicts a pull-down menu finding an optimized solution in accordance with one embodiment of the present invention;

FIG. 50 depicts a window showing an output optimization in accordance with one embodiment of the present invention; and

FIG. 51 depicts a window for the user to save the optimized solution as a new case in accordance with one embodiment of the present invention.

### DETAILED DESCRIPTION OF THE INVENTION

In accordance with the present invention, there is provided a method and software system for utilizing data and associated history matching error to more accurately and rapidly predict the recovery of reservoir fluids, which provides a readily understandable synopsis and analysis of a well bore, a plurality of well bores, and/or a reservoir from which fluids are recovered, and which uses history matching error to produce more reliable pressure-time and production rate predictions for the reservoir.

As used herein, the term “fluid” refers to a liquid, gas, water, a natural gas, helium, or a hydrocarbon such as oil. Also, as used herein the term “HM” represents the term “history matching.” In one embodiment, the present invention first receives, processes, and interprets well bore and reservoir data, such as oil, gas, and water production history, pressure information, permeability, porosity, for the construction of a simulation model of the reservoir. A reservoir simulator is then used to test this model's performance against actual performance data for the well bore and/or reservoir (fluid rates, pressures, and concentrations, for example). A history matching error is calculated based on the simulated model performance and historical performance data, and any inconsistencies between the simulation model and actual performance data are reconciled and adjustments are made to the received data and resulting simulated model. Once a close fit between the simulation model performance and the historical performance data is achieved, the future performance of the well bore and/or reservoir can be reliably predicted. At any time, the calculated history matching error between the simulated and historical performance may be represented as a graphical representation in the form of a plot or map, for example.

Thereafter, the calculated history matching error between the simulated and historical performance may be optimized in the present invention using a neural network. Neural networks are a well-recognized mathematical technique that analyze large quantities of data and develop relationships between the independent variables in the data and the dependent variables in the data. The neural network of the present invention improves upon the independent variable results given a set of dependent variables. As a result of the optimized solution or solutions provided by the neural network, an optimized simulation model, which most accurately models past historical production of the well bore and/or reservoir, may more accurately predict the future recovery of hydrocarbons from a well bore and/or reservoir.

The following is a description of a method and software system in accordance with the present invention to carry out the above processes. The software may be stored on any medium, typically optical or magnetic, that is capable of retaining the software code and readable by or executed on a general purpose computer system. The software system may be also run over a network, using a typical client-server arrangement.

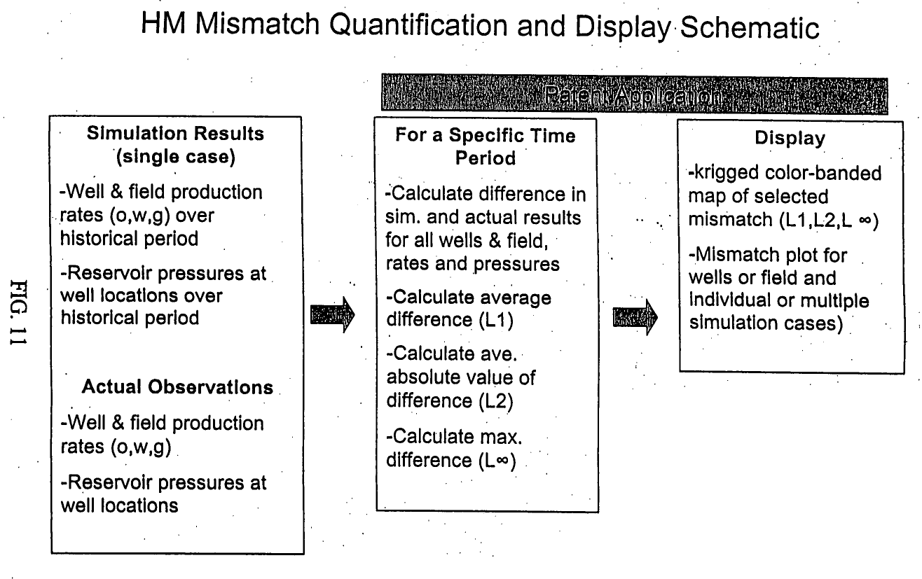

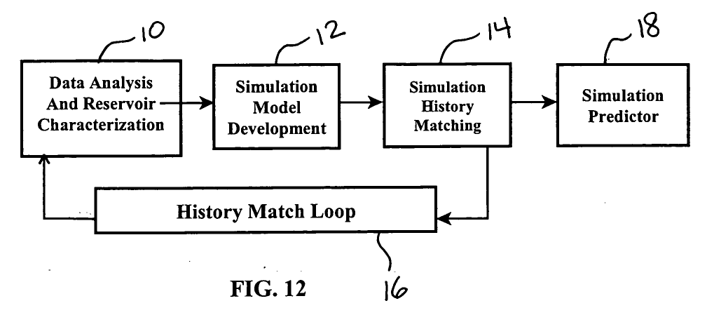

As shown in FIG. 12, in a first embodiment of the system and method of the present invention includes Data Analysis 10 for receiving and interpreting data, Simulation Model Development 12 for consolidating the data into a simulated reservoir model, Simulation History Matching 14 for carrying out interactive history matching or history matching error determination, History Match Loop 16 for modifying a parameter(s) of the original data to iteratively arrive at a simulated model which substantially matches the historical output data for the reservoir, Simulation Predictor 18 for predicting future performance of the reservoir, and Graph (not shown) for representing the calculated history matching error as a graphical (plot or map) representation once a history matching error has been calculated.

In one embodiment, the present invention comprises Data Analysis 10 for receiving data for a well bore of the reservoir and/or the reservoir, and typically a plurality of well bores of a reservoir, to provide a useful description of the reservoir. In one embodiment, the well bore and/or reservoir data may be inputted into any known computing device having a memory using a standard input device as is known in the art. In another embodiment, the desired data may be uploaded to a known computing device by any suitable method known in the art. Data loading may be designed into the system and method of the present invention based on the typical data that is available, and is primarily a process of importing various data types in standard industry accepted formats as are known in the art. In this way, the manual input of information through data specific interactive menus by a user is minimized. The received well bore and/or reservoir data is used to construct a simulation model for the well bore and/or reservoir that simulates the water, oil, and gas output, as appropriate for the specific reservoir, and a pressure-time plot for the reservoir based on the received data.

Exemplary data useful in building a simulation model for a subject to simulate a water, oil, and gas output and a pressure-time plot for the reservoir based on the received data may be, for example, any data related to the structure, layering, layer properties (gross and net thickness, porosity and permeability distributions), faults, natural fractures, fluid saturations, oil-water and/or gas-oil contacts, fluid properties, surface and down-hole well locations, historical well oil, water, and gas production rates (daily, monthly, and/or annual), water and gas injection rates, gas/oil ratio, pressure, permeability, porosity, production performance curves, or any other known parameter or characterization of the reservoir.

In one embodiment, the observed data may include monthly production or injection volumes of phases, (static) reservoir pressure from build-up tests or shut-in observation wells, and (dynamic) bottom-hole pressure data from flowing wells, for example. Preferably, the monthly production and injection volumes are kept as vectors, so the amount of data has minimal affect on the performance (speed) of the method and system. However, since pressure-related information may be considered “spot data,” a large amount of data adversely impacts performance. Because of this, it may be appropriate to reduce the amount of flowing bottom hole pressure (BHP) data before loading.

Data Analysis 10 includes various analyses functionalities that enable any suitable well bore and/or reservoir data to be easily integrated and transferred to Simulation Model Development 12 in a form suitable for the Simulation Model Development 12. These capabilities include but are not limited to, for example, stratigraphic marker review, marker picking, modifying and correlating stratigraphic units, summation of well log results at formation and simulation layer levels, facies and cluster determination, inter-shale determination and modeling, determination of reservoir properties at any layering combination, statistical analysis of any parameter for any layer, statistical analysis of any well log parameter, defining irreducible water saturation from well logs, establishment of free water level(s) from well logs, determination of reservoir compartments from well logs, establishment of capillary pressure functions from well logs, identification of fractures in the well bore from well logs, quantification of fracture and matrix porosity, determination of the distribution of fracture porosity, determination of fracturability from well logs, estimation of fracture connectivity distribution, multi-scale structural curvature (second derivative) analysis, compounding of multi-scale curvature calculations in any direction, comparison of fracture connectivity with well production data, statistical analysis of the reservoir properties, automated variogram generation for sill, correlation distance, and anisotropy, reservoir property mapping through variogram models, object-based sand body modeling, and any other suitable well log or reservoir characterization.

Many of the above capabilities are routine analyses required in developing a simulation model. Some include unique functionalities, such as fracture identification and distribution and reservoir compartment analysis, needed to simulate more complex reservoir systems.

In one embodiment, the present invention may build capillary pressure model(s) based on lithology, porosity, stratigraphy, free water level, and wettability to match log derived water saturations. During this iterative process, the user can specify a single parameter to regress on (e.g., bound water, entry height, lambda, free-water level) while keeping at least some remaining parameters constant, or can perform multivariate regression on all the parameters concurrently. Upon establishment of the representative capillary pressure model(s), the saturation function endpoints are populated for each simulation layer. Using a capillary pressure model that is consistent with log data provides integrity and ensures consistency of the initial fluid distribution in the simulation model.

Consistent capillary pressure models also aid in the identification of multiple free water levels and the associated compartmentalization among the reservoir units. This analysis can be conducted at the geologic or simulation layer level. Compartment boundaries can be easily identified and can be associated with faults or changes in lithology.

In another embodiment, the present invention utilizes conventional well logs to identify fractures in the well bore. This capillary pressure modeling approach matches log-based water saturations over an entire interval. The capillary pressure modeling relies on lithology identification, total porosity, wettability, and free water level. Intervals where the capillary pressure model does not agree with the log results are identified as being impacted by fractures and the total porosity is apportioned between the matrix and fractures. Special techniques may be utilized in unconventional environments (coals and shales) and facies that may not be associated with a classical free water level. Ideally, the analysis is initially carried out on wells with visual data, such as borehole image logs or core descriptions. The capillary model-based fractures are tuned to the visual data. Thereafter, a consistent capillary pressure model may be built, which is applicable for all wells in the field.

Once fracture identification in the well bore(s) is complete, the present invention may further comprise combining structural curvature analysis with fracturability analysis to define areal connectivity of the fractures. Fracturability is a relative measure of the likelihood of the rock to fracture and is related to rock hardness (lithology, porosity and any visual identifiers). Structural curvature is the rate of change of the slope of the structural surface, and reflects the stress history of the formations. The curvature is analyzed over a number of distance ranges to highlight the range of fractures present in the field. Given the current day principal stress directions, fracturability and structural curvature are combined to create a connectivity distribution, which is a relative measure of the connection of likely fractures. These connectivity distributions can be directly exported along with the matrix and fracture porosity distributions to a dual porosity simulator for each geologic or simulation layer.

Thereafter, connectivity distributions may be converted to fracture permeability values by a single permeability multiplier. In this way, the absolute value of the permeability is determined without the need to change the determined distribution. The intensity of the connectivity distribution provides the variation in the fracture permeability values.

Additionally, in one embodiment, there is provided multiple options for Ordinary Kriging (OK) with variogram models, including but not limited to spherical, exponential, gaussian, linear, and cubic. In one embodiment, a thin-plate variogram model (adoption from spline fitting algorithms) may be compiled which is useful in identifying areal discontinuities in the data. The solution algorithms for the correlation matrices have been modified to take advantage of improvements in present-day computers.

In one embodiment, the present invention includes a flexible internal variogram equation that can be used for quick analyses of the data. Upon selection of the property and formation names, multi-variate regression is automatically performed to identify uniform sill and nugget values with corresponding correlation distances for 180 theta bins. In this way, the user can select anisotropy direction and ellipse size interactively.

The internal variogram equation of the present invention is sufficiently robust to represent various combinations of standard variogram formulations. The regression calculations progressively modify the weight factors that enable the capture of the shortest correlation distance(s) permissible. The use of such an internal variogram equation saves significant time in data analysis and model building for the user. This time savings can be particularly important if the property maps have to be updated during the subsequent Simulation History Match 14 (which will be discussed more fully in detail below).

In another aspect of the present invention, the present invention enables the analysis of facies (sandstone, limestone, coal, shale) clusters identified from well logs within a formation to generate vertical proportion curves. Using this information together with various other parameters, the system and method of the present invention may create stochastic realizations of sand body objects that are constrained by hard data (wells) and other soft data.

The three-dimensional object modeling provided by the present invention is capable of handling variations in shorelines both areally and vertically. The user can specify standard geometric sand channel controls for each event such as width, thickness, sinuosity and direction through statistical descriptions.

The present invention is especially powerful for modeling of near-shore depositional environments with the representation of various forces that control the sand deposition mechanism. For each (event) layer, the user can specify one of nine or more available options that describe the balance of fluvial, tidal and wave forces that influence the deposition mechanism. If requested, during stratigraphic correlation analysis, the user can convert the present-day facies thickness observations back to original depositional thickness values. This is especially useful when the user is dealing with facies (such as coals and shales) that yield significant compaction upon burial. When this option is used, the three-dimensional sand object models are generated for the original depositional (uncompacted) conditions, and later are converted to present-day compacted conditions.

While generating the sand objects, the present invention may maintain a color code for each geocellular grid, indicating its relative position to the event top. This information is used to track the tops and bottoms of the channels, and can be used in porosity-permeability assignment. Sand objects are generated such that channel sands can incise into the older depositions.

Once data analysis and loading has been completed the data may be integrated and transferred into a reservoir simulation model using Simulation Model Development 12 with a specific grid and layer system. This simulation model will have input requirements unique to the specific simulator being used, as well as data typically required by all simulation software, such as simulation software currently sold under the trademark ECLIPSE obtainable from Schlumberger, Sugarland, Tex. and simulation software currently sold under the trademark WorkBench® obtainable from Paradigm Geosciences, Houston, Tex.

In constructing a simulation model, the present invention may perform any of the following functions, for example: importing and mapping of unconformity surfaces; importing of three-dimensional fault surfaces; the conversion of two-dimensional fault traces to a three-dimensional surface; the determination of intersection of unconformity and faults with the simulation grid; the calculation and modification of transmissibility values based on unconformity and fault presence; the determination of shale thicknesses between formation and simulation layers; the calculation of transmissibilities based on shale thicknesses between layers; the rules-based activation of transmissibility barriers based on shale thickness; the comparison of geologic well markers to simulation grid locations; the automatic detection of problems in production and completion data compatibility; the automatic location of well string completions from dynamic data; tools to review the rate allocation among the well strings; assignment and modeling of multiple well strings (tubing) into a single well bore; the chronologic assignment of well strings into multiple well bores; the presentation of deviated well bores and multilaterals; the automatic location of completions in matrix and/or fracture grid cells; the automatic determination of production/injection status; the automatic calculation of well down time; the rules based determination of well type (oil, gas, liquid, reservoir); Repeat Formation Tester (RFT) results input for both perforations and entire well bore; gathering center assignments based on well groups; multi-level well group trees for gathering centers; the automatic calculation of gathering center rates; the creation of time dependent data for the simulation results set; upgridding of maps to simulation arrays; exporting of simulation arrays; conditional and mathematical functions for array manipulation; statistics and cross plots for arrays; deck building; or alternatively any other suitable method known in the art for constructing a simulation model.

The present invention may also calculate the intersection of any surface (i.e. unconformity, volcanic intrusions, etc.) with the simulation grid, locate the grid blocks that intersect the surface, determine the direction that the surface intersects through the grid blocks, and create transmissibility traces for the intersecting surface, for example. The present invention may further specify the magnitude of the transmissibility multiplier that will be applied to the transmissibility traces. The transmissibility multipliers can be different for each intersecting surface.

The same functionality can also be used for faults and regions. Sloping faults can be imported as three-dimensional fault surfaces and used directly. The two-dimensional fault traces for vertical faults (or any trace that requires transmissibility modification) can also be imported. Optionally, the two-dimensional fault traces may be converted to three-dimensional fault surfaces.

As with the unconformity barriers, transmissibility modifiers for the grid blocks that intersect the fault surfaces can be specified. The magnitude of the modifier can be the same or different for each fault surface.

The fault traces or inferred transmissibility barriers during subsequent history matching (as described below) can also be created through digitizing, for example, and transmissibility modifiers can be assigned in the same way. In a similar manner, transmissibility modifiers can be specified for regions to prevent or enhance the flow from one region to another. The transmissibility modifiers can be exported in each direction for all types of barriers or traces (faults, regions, unconformity, and the like) as a single modification file or they can be exported separately for testing different features. This automated procedure eliminates the need for manual modification of transmissibility, which is impractical for fields with complicated barriers.

The modeling of the presence of shale among the simulation layers is substantially important for correctly representing the vertical flow within the reservoir. The effect of vertical communication barriers due to the presence of shales is significant for reservoirs that are undergoing aquifer encroachment, water flooding, gas injection, tertiary recovery or even gas cap expansion.

In one embodiment, the present invention streamlines the process of determining vertical communication when shale lenses are present. The presence of shale within the layers impacts the vertical permeability. The thickness of the shale between the layers impacts the layer-to-layer (transmissibility) communication. In one embodiment, the present invention calculates the thickness and the vertical locations of the shale “clusters” through facies analysis of the well logs. The intra-layer shale thickness (the shale present within a layer) is calculated and used in generating of the net-to-gross thickness ratio maps. The inter-layer shale thickness (the shale located between two layers) is calculated and mapped for each geological layer. Transmissibility “barriers” are then activated based on user specified rules using the shale thickness values. The inter-layer thickness maps are used to create and populate a transmissibility “barrier” array for each simulation layer.

In another embodiment, the method and system of the present invention performs quality and consistency checks on the production and completion data and provides an interface to correct the inconsistencies manually or automatically. The present invention thus enables complex completion histories for fields with large numbers of wells to be quickly handled after data has been imported via spreadsheet or text formats into a database. This corrected information is utilized together with the simulation grid and well markers to create the time dependent data for the simulation data set.

Moreover, consistency checks are optionally performed between the production and completion data by scanning through all the production and perforation information and detecting the inconsistencies (production or injection during period where no completions are defined). This functionality is fast and user friendly in the present invention, and also reports inconsistencies and displays production and perforation information graphically for the problem well bores so that the nature of the inconsistency can be visually detected.

Further, data quality checks are optionally performed on the well deviation surveys. This consistency check is carried out before the well completions are located in the simulation grid. The well deviation surveys are visualized in all directions and any digitization errors in the data are easily detected and fixed. The trajectory of the deviated wells in the simulation grid can also be visualized to ensure that well completions are located correctly. The present invention can create all the required time dependent information for the simulation model. While doing this, the present invention automates many processes and includes the necessary modifications during history matching.

The PI (productivity index) is a parameter that is occasionally modified during history matching. When different completed zones produce different fluids at different ratios, tuning of the PI may be necessary to adjust how much each zone produces in order to match the total well production history. This tuning is more significant when the well has commingled production from isolated intervals.

In one embodiment, the present invention automatically calculates a PI multiplier based on the amount of simulation layer penetration. If the completion is fully penetrating the simulation layer, no PI multiplier is applied; if the well is partially completed in a layer, then the penetration ratio is calculated and the PI is reduced by this factor. Horizontal wells may require a PI multiplier greater than 1.0. Next, there is optionally provided an interface where the user can specify PI multipliers for each perforation. The same capability is also available if the PI is multiplied for the entire well without changing the relative distribution of PI's for each layer.

In addition, the present invention may reduce the data set editing time by calculating, assigning, and exporting well and time-dependent properties. In addition, the present invention can automatically assign well types based on the rules specified by the user. For example, the user can set a certain threshold value for water-oil ratio (WOR) and when the historical WOR for the well is greater than the specified value, the well becomes a “liquid” well and is constrained by the liquid rate for that time step.

In one embodiment, the present invention calculates connection (completion) relative permeability endpoints if requested by the user, calculates the relative penetration, and determines a relative permeability endpoint scaling factor for the concerning connection. If required by the user, the present invention may include the necessary keywords in the simulation data set to optionally turn this feature on.

In another embodiment, the present invention assigns the minimum and maximum limits for the rates and pressures when defined by the user and has the capability of assigning wells to gathering centers and creating the group tree. The present invention optionally calculates the down-time for each well for each time step and incorporates this information into the simulation data as well.

Additionally, the present invention can work with multiple simulation models within the same project. Using model merging or model stacking objects, it is possible to create a unified data set where the well perforations can be located in multiple simulation grids concurrently. The dynamic portion of the data set reflects the perforation ordering for the commingled wells accurately.

The system and method of the present invention may further handle wells in dual porosity or dual permeability reservoir models. In one embodiment, the present invention supports the simulation models where the fracture environment is represented as separate layers. Through the detection of the grid block properties, well completions are generated in the matrix and/or fracture simulation layers in correct order.

Alternatively, if a simulation model has already been built, the simulation results from any suitable simulation software, such as for example, Schlumberger's Eclipse100 and Eclipse300, Scientific Software-Intercomp's Omega, and Paradigm's SimBest II, Comp4, and Comp5, may be loaded to provide the simulation model. For example, the simulation model can be in the form of binary code, and the binary results can be loaded. In one embodiment, well rates and pressures for each time step can be loaded. Preferably, files containing rate information should be written in binary format when making simulation runs.

Once Simulation Model Development 12 builds the well bore and/or reservoir simulator, the reservoir simulator is then used to test this model against actual performance data (fluid rates, pressures, concentrations) by Simulation History Match 14. The modeling process is preferably an iterative process and is generally referred to herein as “history matching.” In reservoir simulation, future performance of the well bore and/or reservoir may be predicted reliably with the simulator if the simulator in the history matching process can reproduce the past performance of the reservoir. The lower the history matching error between the simulated model performance results and the historical performance, the closer the “history match” that exists.

In one embodiment of the present invention, Simulation History Match 14 tests the simulation model against actual performance data for the reservoir (fluid rates, pressures, and concentrations, for example) and calculates various types of history matching error based on the simulated and historical results, and any inconsistencies between the simulation results and actual performance results are reconciled and adjustments are made to the received data and resulting simulated data. Thus, in the history matching process, any inconsistencies in the simulation model results when compared to actual performance results must be reconciled and adjustments made to the simulated reservoir model until the history matching error or deviation is equal to or less than an acceptable predetermined value.

The present invention includes numerous capabilities to speed the analysis of history matching results and the creation of the next history matching run. For example, the present invention provides for speed and efficiency by automating the data adjustments and processes that are conventionally done manually and/or by providing analysis tools that aid the simulation engineer in decision-making. As the present invention provides an integrated history matching environment, it is possible to make changes quickly at the source data level (mapping, capillary pressure model, fracture distribution, etc.) to ensure consistency, accuracy and integrity of the simulation model constructed by History Match Loop 18.

The history matching process may be greatly enhanced through one or more of the following functionalities: rapid loading of simulation case results; flexible predefined and user defined plots of field, group and well history match results; grouping of the history match plots based on well type and/or location; management and reporting of multiple simulation cases; reporting of observed RFT (repeat formation tester) data and well log saturations against comparable simulation results; reporting of observed PLT measurements against comparable simulation results; mapping of pressure mismatches over specified time periods; mapping of production/injection phase mismatches over specified time periods; three-dimensional visualization of array results; dynamic results animation of array results; visualization of array cross plots and histograms; PI multiplication for the individual completions or the entire well; automatic PI calculation based on completion interval; automatic completion relative permeability calculation based on completion interval; speedy identification of reservoir compartments (locations and fluid contacts); rapid modification of transmissibility multipliers for faults and other barriers; easy modification of property arrays; HM (history match) parameter-HM (history match) quality sensitivity analysis; HM (history match) parameter range guidance based on “mismatch” error criteria; and/or alternative parameter selection for improved HM (history match) quality. As discussed below, a HM (history match) parameter refers to any suitable parameter to characterize a well bore, a plurality of well bores, and/or a reservoir.

The key to a successful history match determination in the present invention is the proper identification of the ‘mismatches’ between the actual data and the simulation model. The mismatch may increase or decrease with time and is variable from well to well throughout the field, as well as over time.

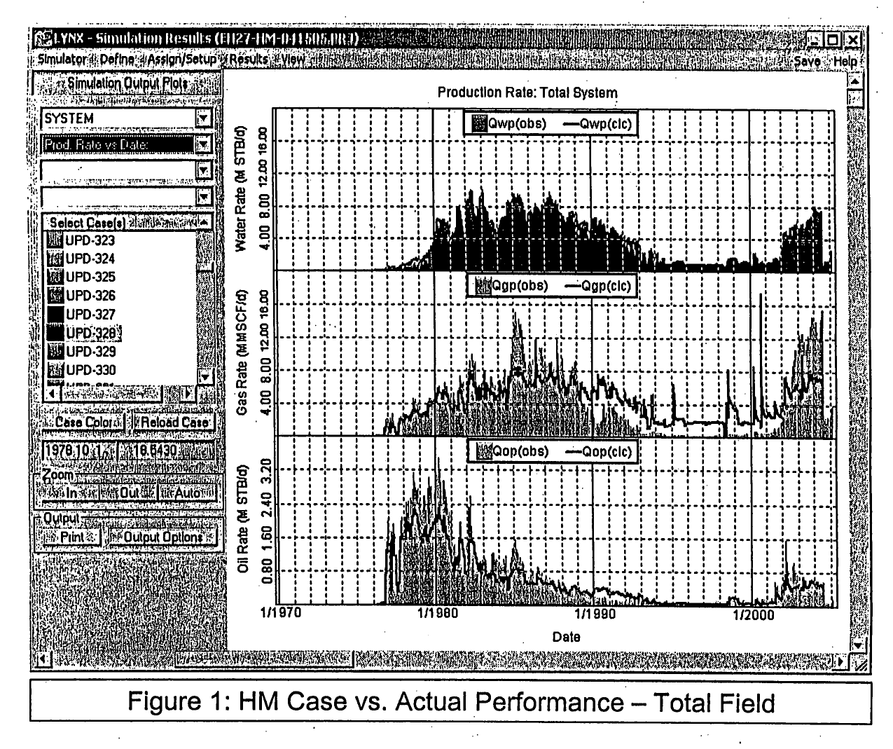

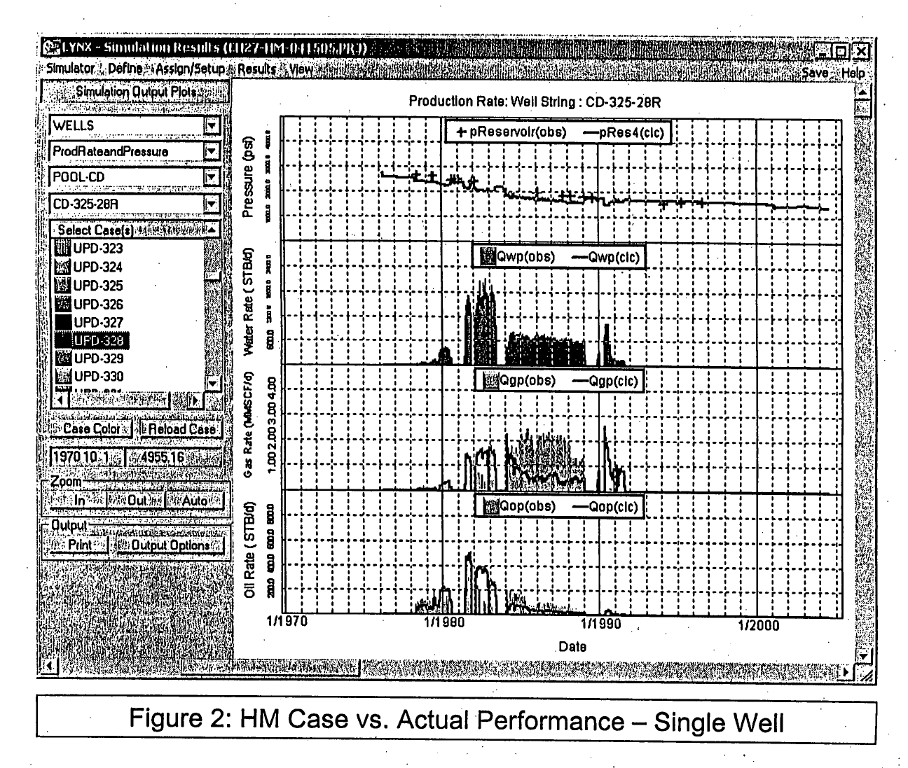

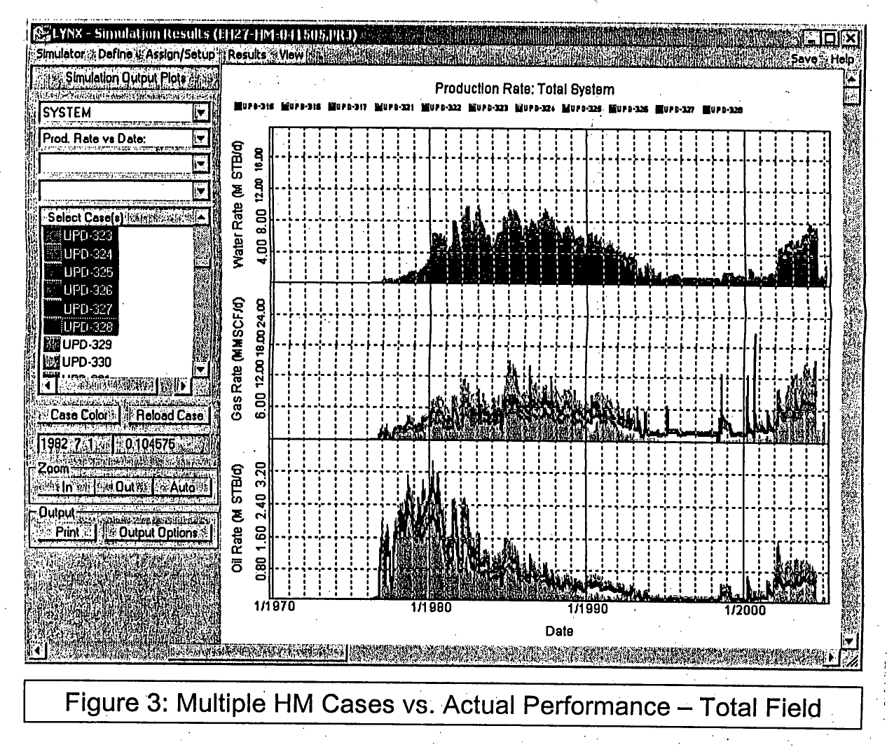

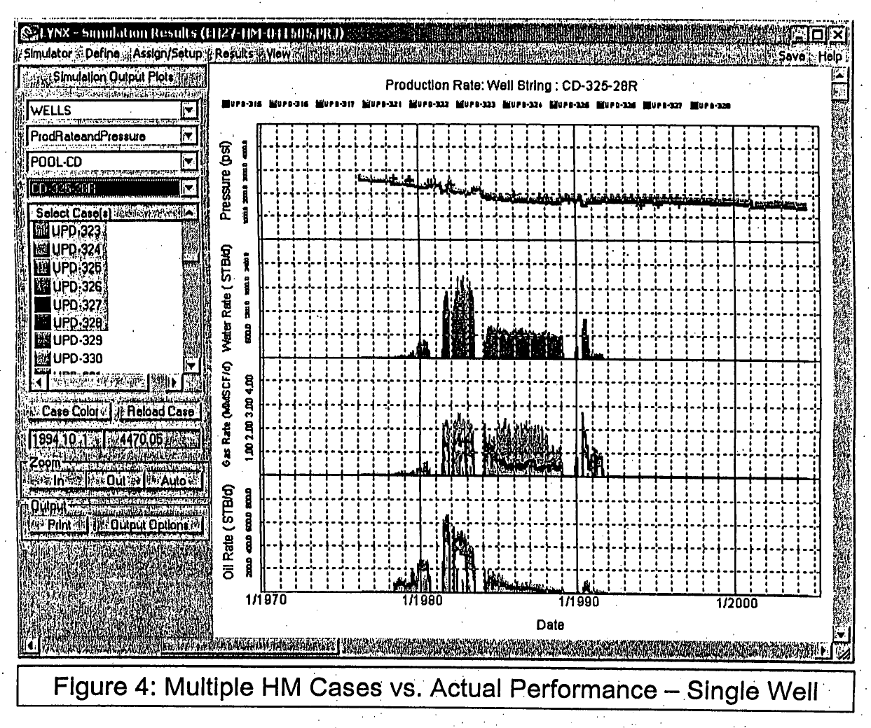

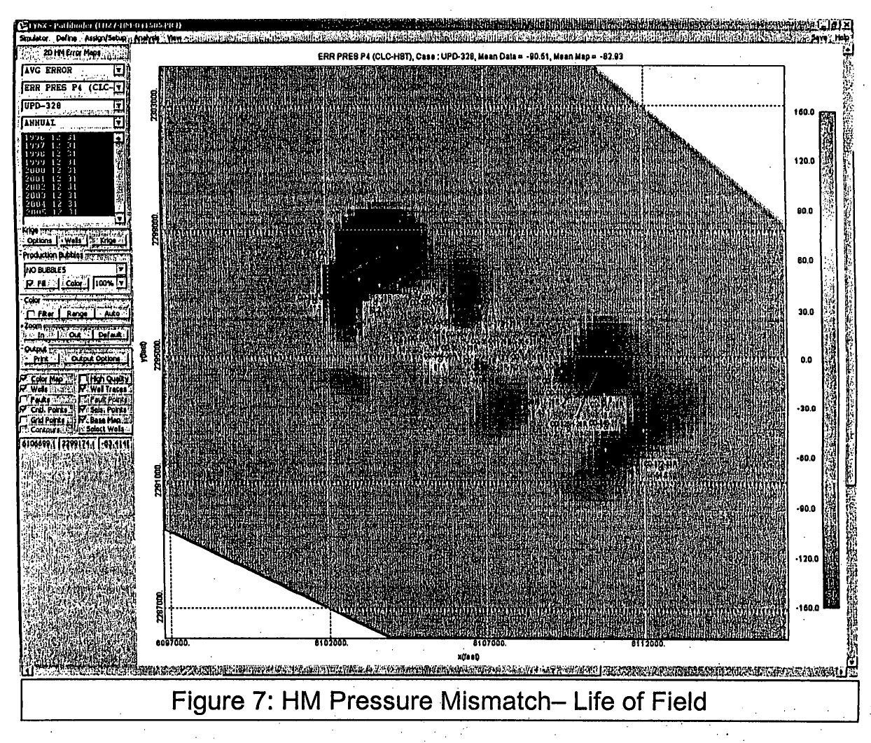

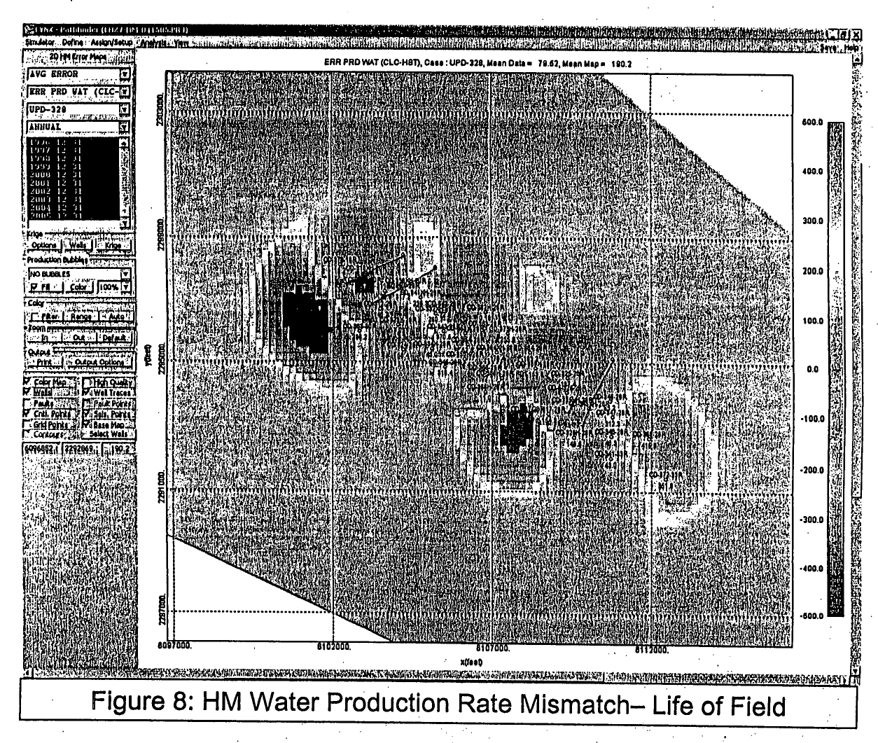

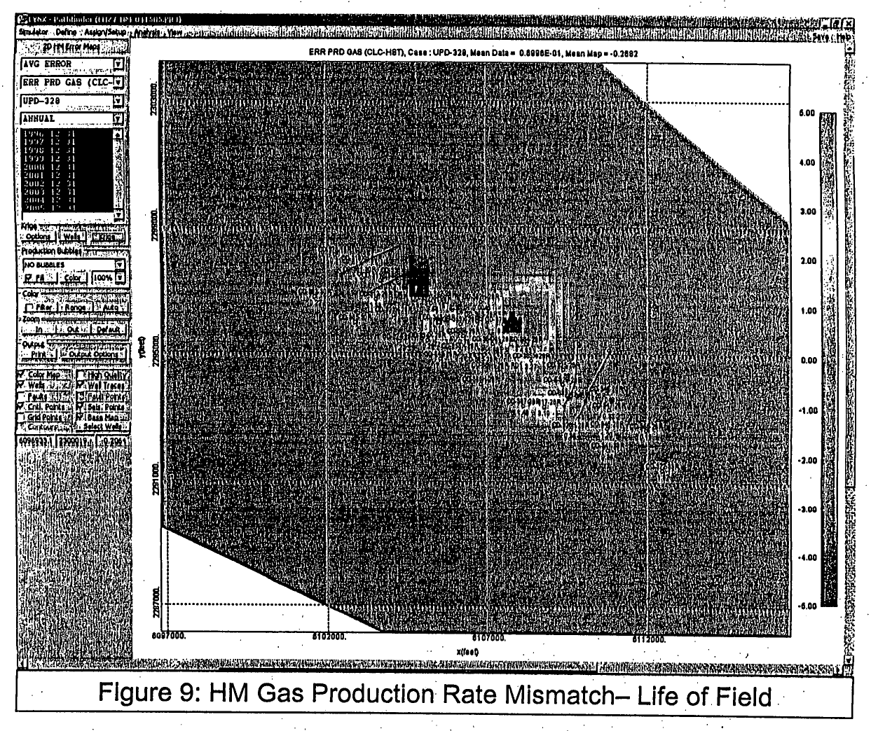

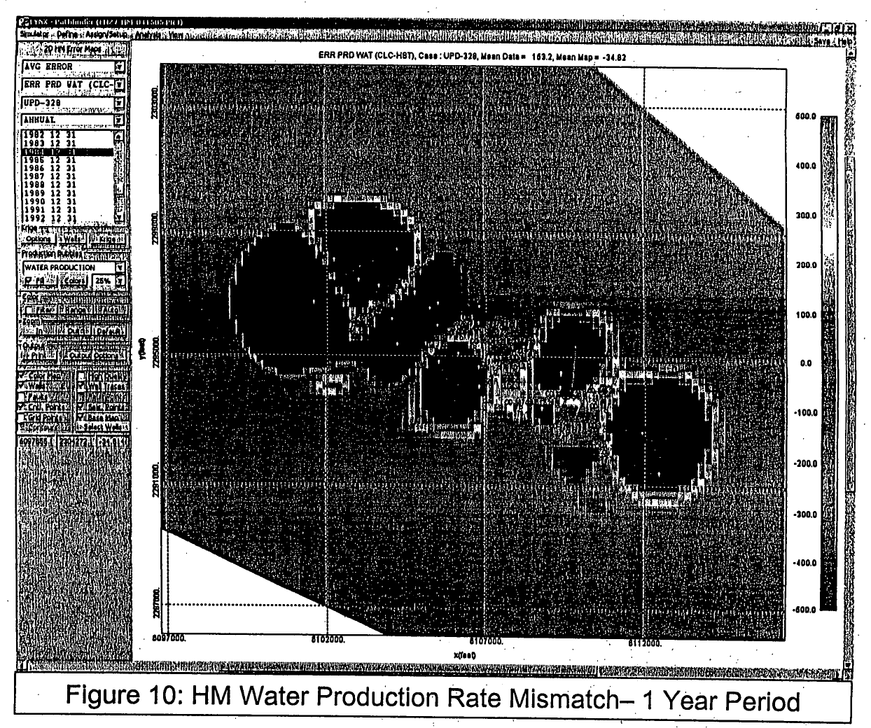

In one aspect of the present invention, the method and system calculates the difference between the simulation model results and the observed historical reservoir performance, for example, for pressure and the production of all three phases for each time step, and also provides a quantitative measure of the mismatch over time or the cumulative/average mismatch within a period of time. These values can be easily mapped and graphically represented using Graph or Map, allowing a quick identification of the problem areas in the simulation model, as shown in FIGS. 1-11. In so representing the history match error or mismatch error information for one or more well bores and/or the reservoir, any suitable method of graphical representation as is known in the art may be utilized. By representing the error graphically (plot or map), the user is more readily directed to the determination of regional property modifications for the next history match run.

The history match error may be quantified for each fluid phase reported in the historical production, as well as the reservoir pressure at each well with the results being graphically displayed. In this way, simulated well and field production rates (oil, water, gas) as well as reservoir pressures at well locations over a historical period can be compared to actual historical well and field production rates (oil, water, gas) and reservoir pressures at well locations over the same historical period.

In this embodiment, the present invention may calculate the difference between the simulated data and the actual data to evaluate the mismatch in any one of three different ways. First, L1 represents the average mismatch during the specified time period. L2 represents the average of the absolute value of the mismatch during the specified time period. L∞ represents the maximum mismatch during the specified time period. Different mismatch values for different parameters can be displayed for different history match cases to evaluate the history matching improvement from case to case. The displayed graphical representation may be a krigged color-banded map of a selected mismatch or a mismatch plot for selected wells in the field and individual or multiple simulation cases.

The process of matching historical pressure data with the simulation model is a technically challenging task. The present invention speeds the matching process by providing a number of tools that simplify the simulation results analysis and the “next” step adjustments to improve the history match. First, all the available pressure data (static pressure, BHP, RFT) can be loaded and analyzed within the computing device. The present invention then makes the necessary adjustments to the display of data (i.e., correcting pressure values to the depth of interest) so that the data can be compared with the simulation results.

For the calculation of the pressure mismatch or history matching error, the observed pressure data is compared to the pressure reported by the simulator. A different weight factor can be assigned to each pressure measurement. Depending on the reservoir quality and the type of pressure measurement, the observed pressure may be compared to P1 (pressure of the cell where the well is located), P4 (average pressure of the 4 cells surrounding the well), P5 (average pressure of the cell where the well is located plus the 4 cells surrounding the well) or P9 (average pressure of the cell where the well is located plus the 4 cells surrounding the well plus the 4 cells diagonal to the well cell). The present invention allows the user to select the simulated pressure to use for mismatch calculation.

When compared to actual observed pressure, mismatches in the simulated model may occur at any point during the field's history. The pressure mismatches may increase or decrease over time and may vary from well to well throughout the field, as well as over time.

In addition to the conventional pressure versus time history match plots for individual wells, the present invention also provides pressure mismatch maps which allow the user to quickly identify problem areas in the model both areally and over time. This focuses the user on the problem areas and helps to determine the global and regional property modifications permeability, faults, barriers, etc.) for the next simulation model history matching run.

Any static (porosity, permeability) or time dependent (saturations, pressures) array can be displayed in a three-dimensional visualization environment by any suitable method known in the art. Any property can be displayed with the structural contour lines to enhance visual clarity. Time dependent parameters can be tracked via an array animation facility, for example.

In addition to conventional grid-slicing capabilities, the present invention may also create grid fence diagrams based on well locations. Upon selection of a specific well, the present invention automatically creates two cross sections along the I and the J locations of the selected well. This well view can be saved as a template for future use. This feature can also be used to create fence diagrams for multiple wells.

The present invention optionally provides unique graphing capabilities using array analysis tools, such as array cross plots and histograms to review the relationships between the arrays and statistics of the grid properties. These tools aid the engineer to perform consistency checks after each modification made during the history matching process.

As is also shown in FIGS. 1-11, the present invention may also display as a graphical representation any number and type of history match plots in any size, stacked vertically. It is very easy to toggle between well, gathering center and field plots, for example. The user may scroll between plots by using the mouse scroll, by keyboard arrows, by picking the well name from a list, or by any other suitable method of selection. Any suitable input device can selectively modify the ranges of the axes and any suitable input device can similarly change templates. When necessary, a rectangle zooming tool is optionally used to magnify selected data in time scale. Additionally, multiple simulation cases can be displayed and case colors can be customized. The legends and titles of the plots are automatically assigned based on the cases and the data type.

Accordingly, the present invention provides a history matching mismatch (“HM mismatch”) that is a quantitative means of reporting the history matching error (“HM error”) in a simulation run when comparing historical and simulated performance of a well bore, a plurality of well bores, and a reservoir. This mismatch can be displayed in map and graphical plots. The quantitative mismatch is also useful in the analysis and calculation of the sensitivity of individual history matching parameters (adjustments to the simulation model to achieve a HM) during the history matching process as will be discussed below.

Graph or Map optionally assigns a particular color for a particular value or range of values for the calculated mismatch, or any other desired parameter. The calculated history matching mismatch, for example, may be plotted for a single well bore, multiple well bores, or an entire reservoir over a single history matching case or multiple history matching cases. In this way, the present invention enables the user to gain a quick and thorough understanding of a well bore and/or reservoir's properties and how they impact the well bore and/or reservoir's simulated versus historical performance at any point in time. The user can readily view areas by way of color contrast or color association, for example, which direct the user to area(s) of a well bore and/or reservoir that are or are not behaving as expected. Thereafter, appropriate adjustments to appropriate reservoir parameters may be made if desired as would be appreciated by one skilled in the art.

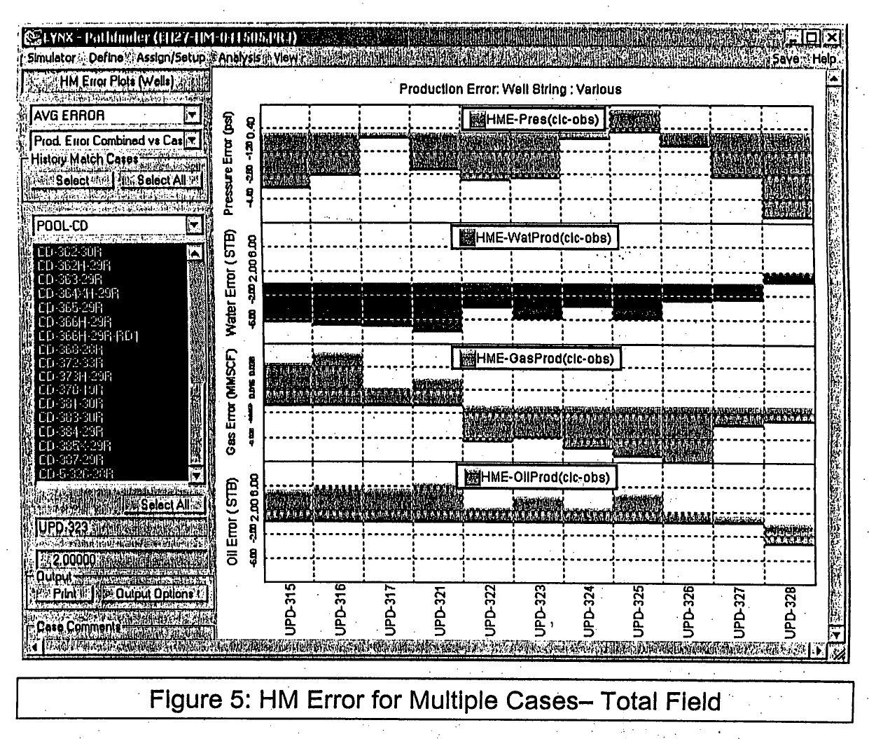

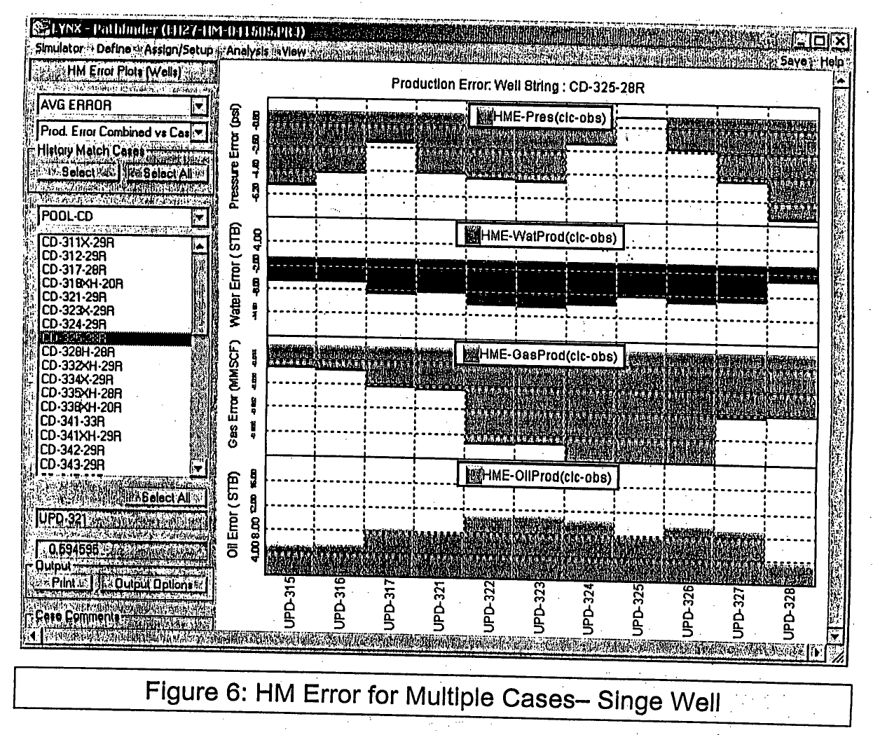

In one embodiment, the history matching mismatch can be displayed as a color-banded, krigged map based on the history matching mismatch computed at each well (FIGS. 7-10, for example) or as a value for a specific history matching run for individual wells or the total field compared to other history matching cases (FIGS. 5-6). These modes of displaying the quality of the history matching results are unique to the industry and are a powerful tool in the simulation engineer's goal to achieve a high quality history match.

When analyzing the history match results, it is often beneficial to focus on specific groups of wells in the same area. Outlining the areal location of the wells using a polygon on the well location map may easily create well groups. Using a well string list can also create well groups.

Further, the well strings in a well group can be categorized by their type (injector/producer) and sub-groups can be created from a well list. When a well group is selected, only the wells in that group are displayed in the well result plots. This functionality facilitates a focused and systematic examination of the results and significantly speeds the analysis time.

In addition to providing conventional history matching plots according to pressure, rate, and the like, the present invention provides the unique and powerful capability to display RFT data along with simulation results. It displays the RFT data points together with the RFT output for a selected time period during the simulation in a depth trace for pressure and water saturation. It is also possible to display the well log of the well in order to view the corresponding formation, layer, and perforations. The results of the simulation are displayed over the entire well, not just the perforations.

The present invention optionally converts the RFT pressures to static reservoir pressures, which are comparable to the simulation pressures. This feature incorporates more observed data into the history matching analysis and may aid the user in making more informed decisions without reviewing the whole suite of RFT information.

Once it is determined that the absolute value of the calculated history matching error between the simulated model and the actual historical data for the well is within an acceptable range or below a predetermined value from Simulation History 14 using History Match Loop 18, the future performance of the reservoir from well to well, including gas, oil, and water production outputs and pressure-time plots, or any other reservoir performance characteristic known to one skilled in the art can be calculated by Simulation Predictor 16. Because the simulated model has been run and rerun to ensure that it is able to reproduce historical data for the well, the present invention provides predicted information that is tested, reliable, and more closely relates to the actual performance of the fluid reservoir.

In accordance with another aspect of the present invention, once the historical well bore and/or reservoir data and simulation model data have been provided and history matching errors between the historical and theoretical model data have been determined, there is provided a method and system of minimizing the history matching error using a neural network. By minimizing the history matching error, an improved simulation model is achieved more rapidly and is provided to more accurately predict well bore and/or reservoir performance. In particular, the neural network identifies the plurality of well bore and/or reservoir parameters (discussed below), and a value of each parameter, that will minimize the history matching error between the actual and theoretical model results.

Neural networks are a well-recognized mathematical technique that analyze large quantities of data and develop relationships between the independent variables in the data and the dependent variables in the data. These relationships can be used to predict or improve upon (optimize) the dependent variable results given a set of independent variables. Typically, the neural network uses a training data set to build a system of neural interconnects and weighted links between an input layer (independent variable), a hidden layer(s) of neural interconnects, and an output layer (the results, i.e. dependant variables).

The present invention utilizes neural network technology to aid the user in determining the relationship(s) between a number of user-selected independent variables and the difference in the simulator's predicted versus historical production and pressure results, mismatches, based on particular values of those parameters. The terms “history matching parameter” and “independent variable” for the neural network are used interchangeably herein. The history matching parameters are any characteristic of the well bore, well bores and/or reservoirs described herein and include such characteristics as porosity, permeability, residual oil saturation, and the like. The mathematical relationship between the independent and dependent variables is referred to as a “correlation model.” The correlation model developed by the neural network of the present invention enables the user to determine which independent variables most impact the dependent variables more rapidly than the known “run/analyze/change/analyze” processes. In addition, the neural network of the present invention provides the user with the best combination of the independent variable values that minimizes the history matching error (dependent variables) between the historical (observed) data (oil, water, gas production and reservoir pressure) and the simulated values of these same data.

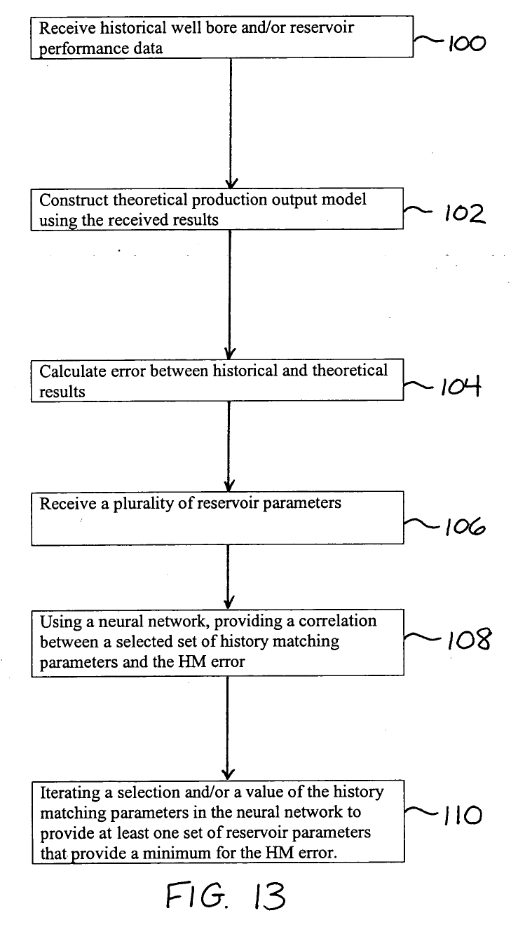

As shown in FIG. 13, the method for providing an improved reservoir simulation model, comprises receiving historical data for at least one of a well bore and a reservoir 100, constructing a theoretical production output model for said at least one of a well bore and a reservoir using the received data 102; and calculating a history matching error between said theoretical production output model and said historical production output data for said at least one of a well bore and a reservoir 104 as previously described herein. In this embodiment, the dependent variables may be the difference between the historically observed and simulator calculated oil, water and gas production volumes and the reservoir pressure at each well in the field or reservoir as discussed herein, for example. The data may include from hundreds to thousands of wells and/or any duration of time (i.e. 10-50 years) worth of monthly production and pressure information, for example.

In one embodiment, the method further requires receiving a plurality of parameters corresponding to properties of the well bore and/or reservoir 106. These parameters or independent variables are typically the well bore and/or reservoir and fluid parameters or characteristics that describe the field or reservoir in the simulation model of that field or reservoir. It is understood that the term “reservoir parameters” as used herein refers to a characteristic of a well bore, a plurality of well bores, and/or a reservoir. From this pool of reservoir characteristics, all or several of the parameters can be selected for use in minimizing the history match in accordance with the present invention. The above-mentioned independent variables may also be referred to as “history matching parameters.” The independent variables may be one or more of a global porosity multiplier, a permeability multiplier, gross formation thickness, net formation thickness, residual oil saturation to water, residual oil saturation to gas, critical gas saturation, free water level, capillary pressure threshold pressure, initial oil saturation, a relationship between porosity and permeability, initial oil bubble point pressure, rock compressibility, PVT characteristics, or any other characteristic of the well and/or reservoir. In addition, these independent variables likely are changing across the reservoir and vertically.

The dependent variables are either known via measurements in the field, by inferences based on other parameter measurements or by fundamental equations of state, flow equations or laws of thermodynamics. The independent variables needed to describe a reservoir in a simulation model are known with varying degrees of uncertainty. It is this uncertainty in the definition of these independent variables that often makes the reservoir simulation history matching process difficult.

In one embodiment, a neural network is first trained using any one or more of the historical well bore and/or reservoir data, the simulated well bore and/or reservoir data, the history matching error (representing a difference between the historical and simulated well bore and/or reservoir data, and a set of independent variables (or history matching parameters). The trained neural network is then used to determine a set of independent variables and their values (which describe the well bore and/or reservoir) and which minimize the history matching error for the well bore and/or reservoir. In one embodiment of the present invention, the training set used to train the neural network includes both dependent variables (i.e. historical well and/or reservoir data) and independent variables (i.e. the parameters which describe a characteristic of the reservoir).

If the data for the independent variables and dependent variables is large enough, the neural network will have sufficient data to construct an initial correlation model based upon the training data. It is understood that the neural network can be trained using changes in any one or any combination of any of the independent and dependent variables previously described. The trained neural network may be installed on the computer to provide analysis of expected changes in the simulation model corresponding to changes in any one or combination of the independent variables.

Once the neural network model is trained, the initial correlation model can be constructed. The present invention further comprises using the neural network to provide a correlation, i.e. a correlation model, to provide a correlation between the dependent and independent variables, wherein the independent variables can be varied using the neural network 108. By varying the particular selection of independent variables and a value therefore, one or more sets of independent variables can be provided which will minimize the history matching error. The correlation model can rapidly analyze, and in one embodiment, graphically display the sensitivity of the history matching error to the entire value range of each independent variable. When a correlation model is developed, the neural network parameters (weights) may be maintained within any suitable memory device. Additionally, when including additional cases and corresponding simulation results, the correlation model may be improved by repeating the calculation. It is contemplated that each time the correlation model is constructed the correlation can be improved to obtain better accuracy. For example, the most desirable results may be obtained when the correlation accuracy is over 99.8% and when the maximum history matching error is minimized to below 0:15.

The correlation model may be utilized for multiple purposes. In its simplest application, the sensitivity of mismatch (history matching error for each phase, pressure etc.) may be analyzed for specific history matching or reservoir parameters for selected wells or group of wells or for all the wells in the model (the whole reservoir). The n-dimensional correlation surface (model) may be displayed in 2-D plots and 3-D plots, for example. Visual display of the sensitivity of the history matching error to the independent variables can aid the user in determining independent variable domain refinements, i.e. sub-domain analysis.

For each independent variable, the method further comprises receiving a domain for each variable such that the neural network iterates the value of a selected independent variable within the domain. The domain may be integer, real linear, or real logarithmic. If there is a large uncertainty associated with the independent variable, logarithmic is recommended. If the variable is discrete rather than a continuous number, for example, the use of different curvature scales used in calculating fracture connectivity maps, integer is recommended. In the present invention, once given sets of independent variables are defined, the set of variables can be saved and utilized as desired.

In order to search for an optimized solution or multiple solutions, the next step is to define an objective function for the neural network. The objective function can be a weighted combination of production (oil, gas and water) volume errors, injection (gas and water) volume errors and pressure (static reservoir and dynamic BHP) errors. Any one or more well bores and/or reservoirs can be selected for definition of the objective function or all of them can be included.

In one embodiment, for any of the volumetric errors, the history matching error for gathering centers or the total field calculations can be used rather than the summation of individual wells. This feature is particularly important if there are production allocation problems with the data. For example, if the field-wide gas production is known with high certainty, but the allocation of production to individual wells is relatively uncertain, it would be preferable to select total field gas production error. Selecting the sum of the gas production error for individual wells will not be desirable for the objective function.

The objective function can be modified at any time. For example, when the user is close to obtaining an acceptable history match and has narrowed down the independent variables to their most likely values, the present invention enables the user to set the objective function based on a few well bores for fine-tuning of the results. Alternatively, the objective function may be modified to seek alternate optimized solutions. In one embodiment, modification of the objective function does not require re-running of the simulation cases or re-generation of the correlation model that significantly accelerates the history matching process for the user.

The definition of the objective function together with the available correlation model enables an optimized solution or solutions to be provided. The optimized solution(s) includes a set of selected independent variables and values for each of the selected variables that minimize a history matching error between historical well bore and/or reservoir data and the simulated production well bore and/or reservoir data. Typically, the optimized solutions are obtained by iteratively varying at least one of a selection and a value of the parameters (independent variables) in the neural network to provide at least one set of reservoir parameters having values that provide a minimum for the history matching error 110.

It is understood that the optimized solution(s) may further include independent variable values thereof that have not been selected by the user. In one embodiment of the present invention, the method uses at least one genetic algorithm to find an optimized solution or solutions. The genetic algorithm provides the capability to search for the optimal solution even if the independent variables are real (linear or logarithmic) variables. This is a significant advance over known standard genetic algorithms that impose the limitation of having binary or integer variables.

To search for the optimized solution (global minimum), any or all of the independent variables can be selected that are available to the user using any suitable input device. For example, any one of the history matching parameters (independent variables) can be assigned a value (for example, a porosity multiplier equal to 1.05) and have the genetic algorithm search for the best combination of the remaining independent variables that will minimize the objective function in the neural network. Once the result is found, the set of independent variables can be saved as a case to be run. In one embodiment, several optimized solutions can be generated with different objective functions.

For example, in minimization/maximization problems, the alternative to genetic algorithms is the well-known technique of gradient search methods. For the gradient search methods to work properly, the software has to pick a starting point that will ultimately result in finding of the global minimum. Short of this, the gradient search methods will find a local minimum and not the global minimum. Additionally, with a very complicated correlation model that has discontinuities (due to integer variables) the calculation of the appropriate derivatives (the Jacobian) or second derivatives (the Hessian) is almost impossible.

Unlike the gradient search methods, genetic algorithms as used in the present invention increase the likelihood of finding a global minimum given that a correlation model exists. The genetic algorithm search method of the present invention is extremely robust in finding the global minimum and has been extensively tested for this purpose.

In one embodiment of the present invention, the invention utilizes a plurality of orthogonal runs to ensure the best coverage of the variable space for subsequent correlation model creation. For example, if 10 independent variables have been defined, the present invention can create a maximum number of 20 orthogonal runs (which is twice the number of independent variables). Alternatively, random cases and/or maximum distance cases can be created.

In accordance with another aspect of the present invention, complimentary to the optimized solution is the capability of the present invention to generate multiple solutions. Using the existing correlation model and the objective function in the neural network, multiple solutions (selected sets of independent variables and values thereof) can be generated through Monte-Carlo simulation. To do so, typically, the number of iterations to make (such as 30,000) must be specified and the number of solutions to retain (such as 100) must be specified. In this embodiment, the present invention retains a desired number of solutions that meet the objective function criteria by minimizing the history matching error.

Thereafter, any desired statistical analysis can be performed on the multiple solutions that were retained. For example, for a selected independent variable, it is possible to observe that all the solutions are skewed towards one limit or contained within a portion of the domain. Provided that there is an adequate number of history match runs, the domain limits of the independent variables can be lowered. This process is called the sub-domain analysis. Sub-domain analysis and user-applied limits help constrain the search domain for the optimized solution and the Monte-Carlo simulations. As a result of domain and subdomain analysis, the neural network will iterate the independent variable only within the selected domain and subdomian, thereby providing more focused results.

In another aspect of the present invention, the present invention comprises clustering the multiple solutions provided by the Monte-Carlo simulations. In one embodiment, for clustering calculations, the present invention uses the well-known nearest neighborhood (Euclidian distance) approach. The algorithm is very similar to those that are typically used in neural networks classifiers. The present invention particularly provides flexibility to the user in deciding the number of clusters to be generated. In one embodiment, up to 10 clusters can be generated. Once clustered, the present invention provides the optimum solution (minimum objective function) and the number of solutions within the cluster. The reported number of solutions can be used to determine the probability that should be assigned to the optimum solution in each cluster.

The benefit of the clustering is two-fold. First, during the history matching process, the clustered solutions can be used as alternative runs to make. This is particularly useful in the early stages of the history matching process when only a few simulation runs may exist and the correlation model is approximate. It is contemplated that in the early stages of the history matching, this is a preferred approach.

The second benefit of the clustering is related to prediction runs. At the end of the history match process, the optimized solution only represents the best (minimum) objective function. If the user wishes to use multiple solutions with assigned probability values, the clustering provides this capability. It is recommended that the user should select the number of clusters to be generated is based on available computing power because the prediction runs must be repeated for each cluster solution.

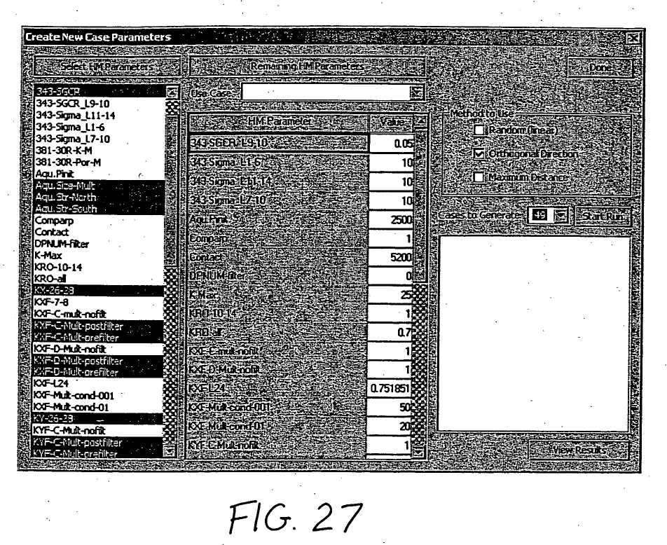

In operation, in one embodiment of the invention set forth in FIGS. 14-51, a system and method for accelerating and improving the history matching of a reservoir simulation model works as follows. First, the user may open the history matching improvement program for use.

As shown in FIG. 15-16, the user first defines history matching cases by one of several available methods. These cases are the results of history matching as discussed herein that results in an error (mismatch) between historical results and simulated results for at least one well bore and/or reservoir. Cases may be created automatically, or alternatively be entered manually. When entering cases manually, before the user loads simulation results, the user typically explicitly defines each case, as discussed below. It is not recommended to rename existing cases and loading results over the existing information. For certain situations, this can result in inheriting undesired information from the previously existing case. In most layouts, cases are presented in the order that they were entered.

As shown in FIGS. 17-18, to define the history matching parameters (independent variable), the user selects “Define HM Parameters” from the available screen menu. To define the history matching parameters, the user specifies the type and range. The type is one of Real (linear), Real (logarithmic) or Integer. The user may insert a new parameter by clicking a mouse button, for example. In one embodiment, the history matching parameters are displayed in ascending alphanumeric order (numbers come before A Z). The range typically covers the variation in all the simulation cases.

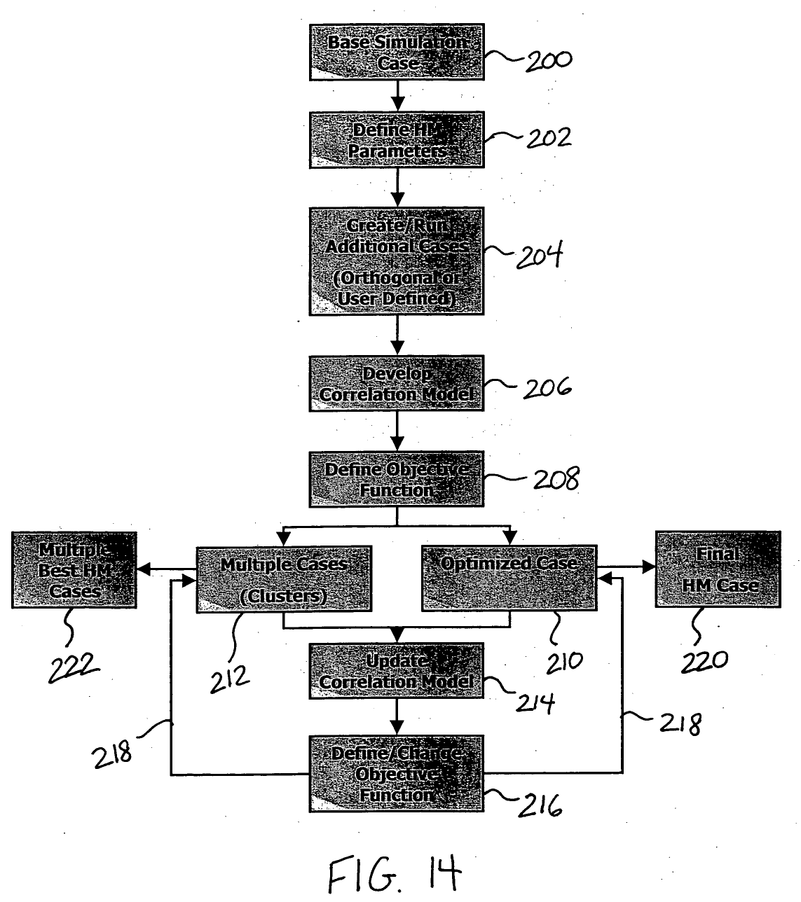

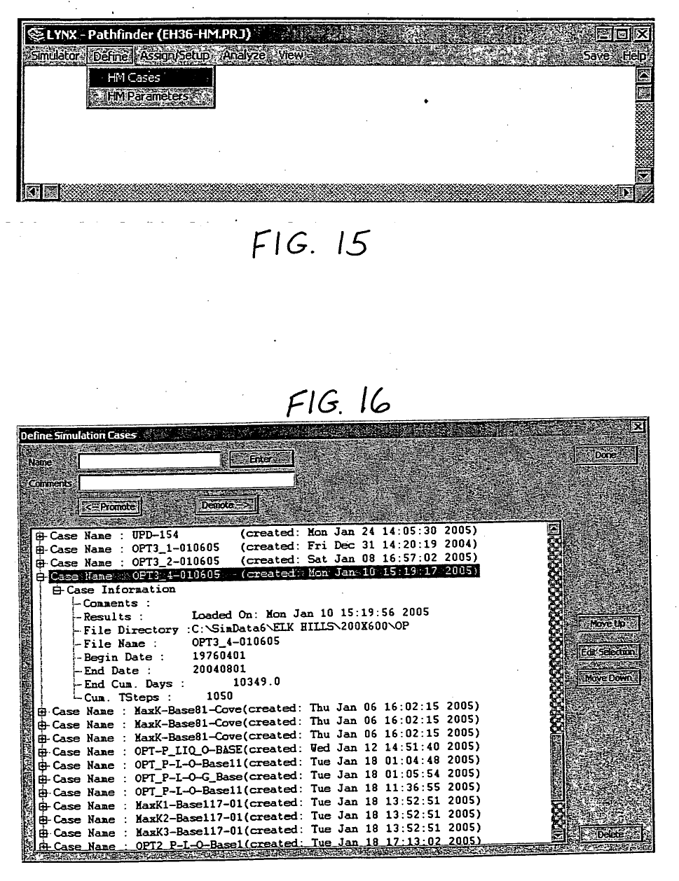

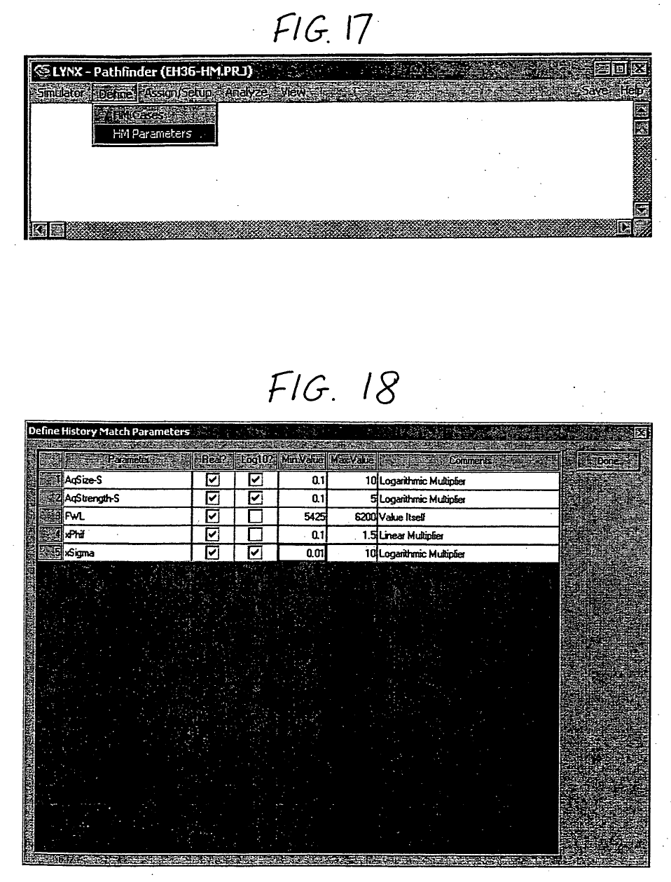

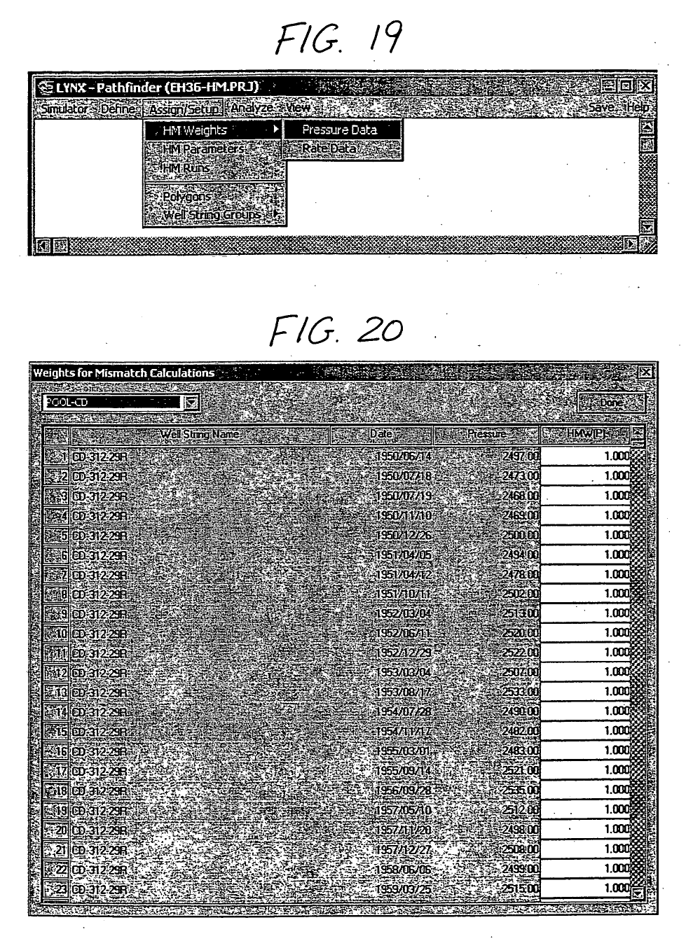

As shown in FIGS. 19-20, to assign history matching weights for pressure data to be used to calculate the history matching error (mismatch), the user selects Assign/Setup/HM Weights/Pressure Data from a pull-down menu. By default, all observed pressure data have the same unit weight. Experience has shown that it is wise to keep the data that is initially perceived to be unreliable, and perhaps find an explanation for its anomalous behavior during the history matching exercise. If unreliable data exists, it is recommended that the user assign reduced (or zero) weight to that data, rather than eliminating it from the database completely. The user can then alter the weights of observed pressure data, and update the learning process, without having to re-load the simulation results.

As shown in FIGS. 21-22, to assign weights for rate data to be used to calculate the history matching error (mismatch), the user similarly selects Assign/Setup/HM Weights/Rate Data from a pull-down menu. The user can then assign weight factors to production or injection data for each well. This assignment is typically performed at the beginning of the history matching process. The weight factors are equal to unity by default. If changes are made, the user may need to reload the simulation results (to update mismatch calculations which are done at the time of simulation results loading) if any of the case results have been removed from the database.

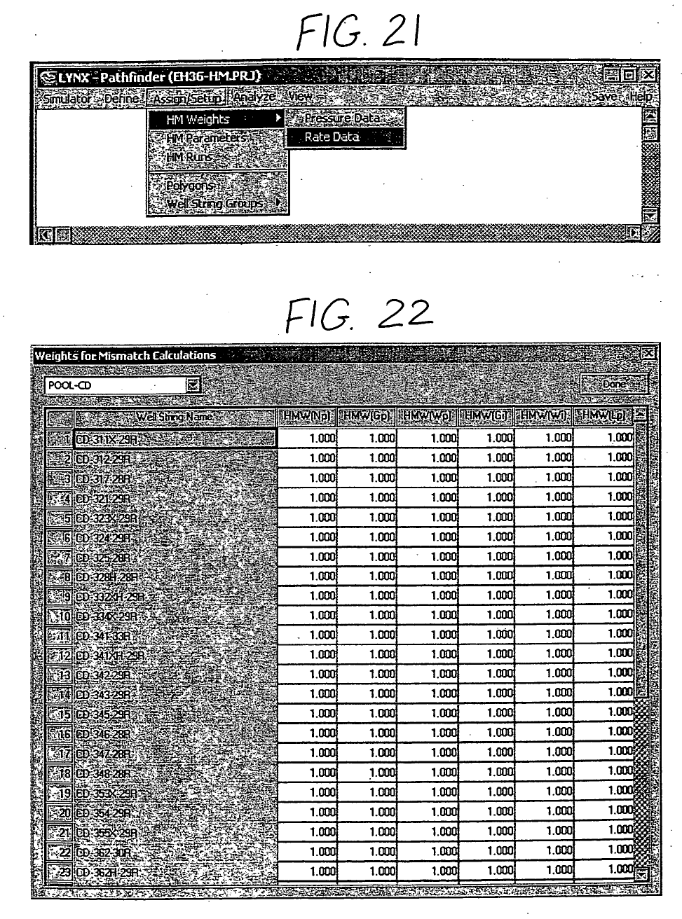

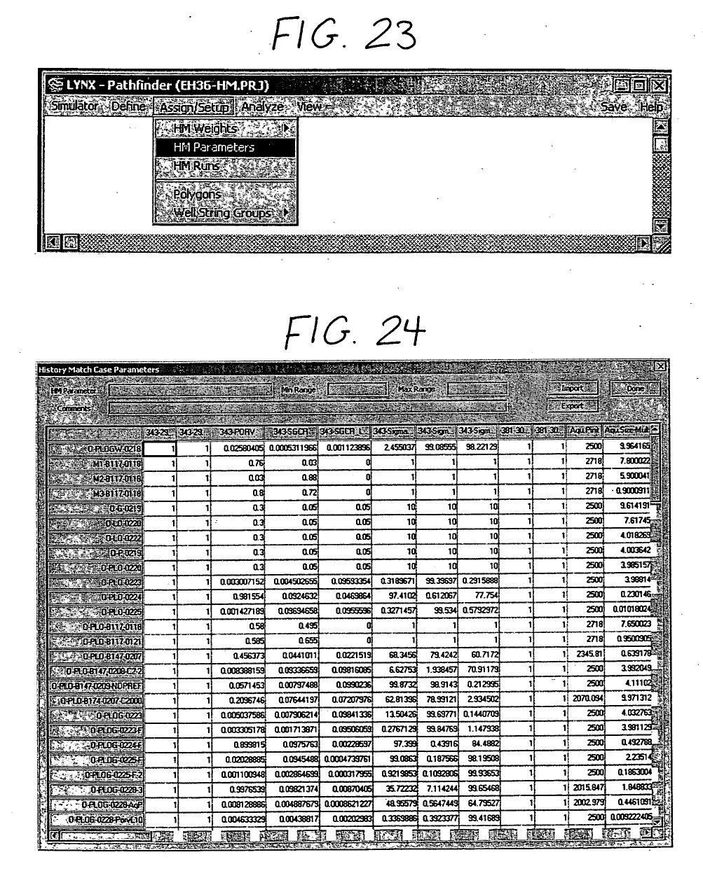

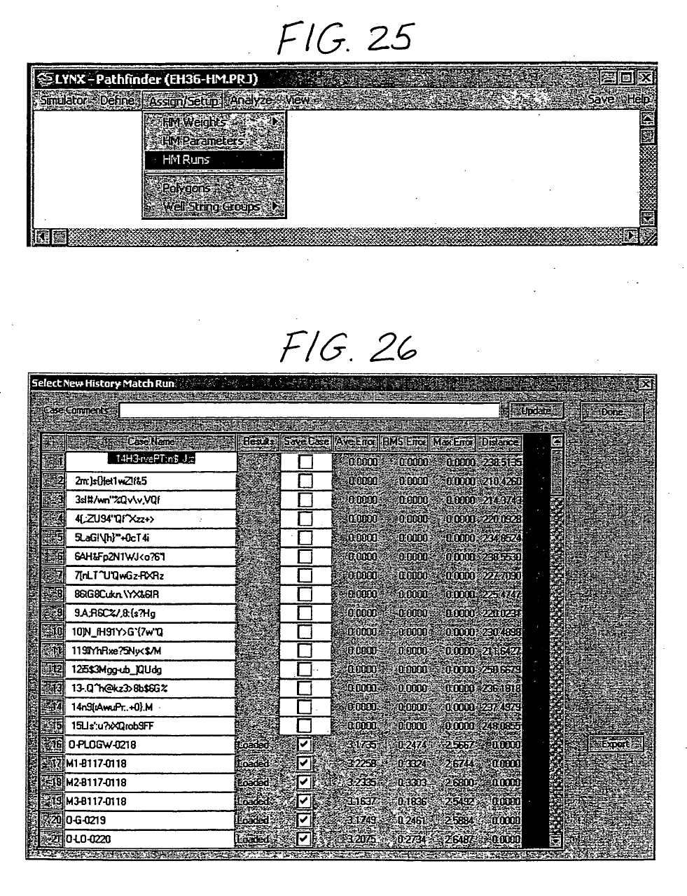

As shown in FIGS. 23-24, to assign history match parameters for each case, the user may select Assign/Setup/HM Parameters from a pull-down menu. The assigning of history match parameters for each case is arguably the most important step in the history matching process. The determination of reservoir characterization parameters or simulation variables that should be classified as history matching parameters requires great attention to detail. If the user is inexperienced in history matching, several sensitivity studies can be performed prior to selecting the history matching parameters to be used. As shown in FIG. 25, a row represents a case and each column represents a history matching parameter. The user may edit individual values, as well as copy and paste from one case to another. The user may also copy and paste from one column (history matching parameter) to another. This can be very useful when the user needs to enter a new parameter that is a subset of an existing one or is similar to an existing one.

As shown in FIGS. 25-27, to create history match runs (cases), the user can select Assign/Setup/HM Runs from a pull-down menu. Prior to creating cases, the user selects the history matching parameters for perturbation. If the user does not select all the history matching parameters, then the user must enter the remaining history matching parameters manually, or use values from an existing case.

In one embodiment, there are three methods to use: random (linear), orthogonal direction, and maximum distance. The random option will create as many random cases as the user desires. The orthogonal direction option can only create a maximum of two times the selected number of HM Parameters for perturbation. When the user uses this option, the first direction is selected randomly, and the remaining set is produced as orthogonal vectors to the first vector and to each other. During the second pass, the directions of all the vectors are negated, yielding two times the selected number of HM Parameters.

The orthogonal option is very useful in covering the full range or variance with a minimum number of simulation runs. To ensure coverage of the full domain, the magnitudes of the vectors are maximized. In return, if the combination of history matching parameters is unrealistic at the extremes, this may result in instability in the simulation runs.

To use the maximum distance option, the user should have at least one case already created. This method will create sets of history matching parameters that are the farthest distance from the existing case(s). The maximum distance option is useful in ensuring that the full range of the search space is covered. As in the orthogonal case, if the combination of HM Parameters is unrealistic at the extremes, this may result in instability in the simulation runs. After generating new cases (with history matching parameter sets), the cases may be saved by any suitable medium.

As shown in FIG. 26, the top fifteen rows show the cases that were generated, each with a randomly selected temporary case name. It may be necessary to rename the cases with a predetermined name if the user chooses to save them. If the user saves any of the proposed as a case, the present invention will automatically update its database, so that the user does not have to manually enter the history matching parameters. In one embodiment, a text file can be created that contains the history matching parameter values for all the saved cases.

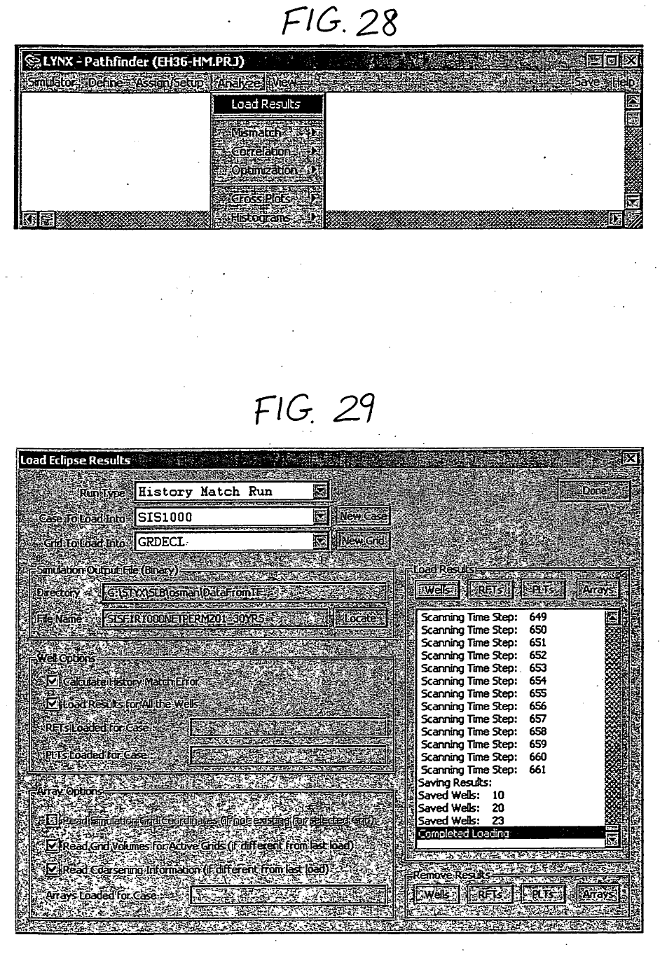

As shown in FIGS. 28-29, the user can then load simulation results for each case that has been run. Typically, selecting options from a pull-down menu as shown performs this process. Before the simulation results can be loaded, the user must select a simulator from a menu of simulators. Assuming that the user has already defined the simulation case and the simulation grid system, the user can select the directory and the results file that correspond to the simulation case file.

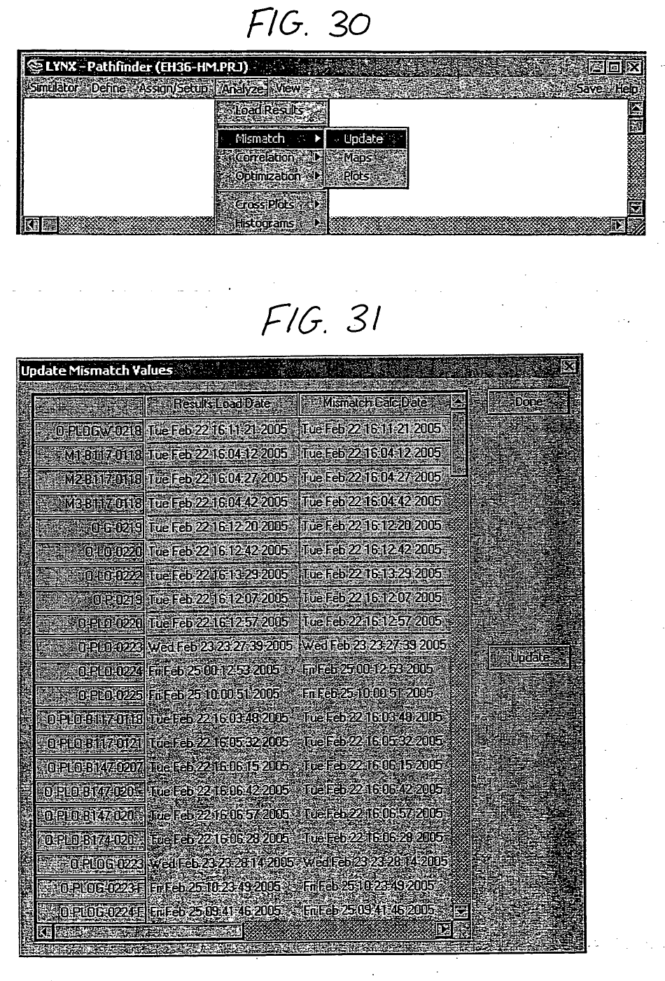

As shown in FIGS. 30-31, to generate updated mismatch values, the user may select Analyze/Mismatch/Update from a pull-down menu. Under normal circumstances, it is not necessary to update mismatch values. However, updating mismatch values may be useful if the user wishes to recalculate the mismatch (history matching error) values for any of the cases. This need may arise, for example, if the user introduces new historical data (production or pressure) or if the user changes the time span of the history match period. If the user has removed the simulation results of a case from the database, the results typically will have to be reloaded. In that situation, the mismatch error calculations can be accomplished during the loading of the results (as explained in the previous section), which means the user will not need to update them using the above process.

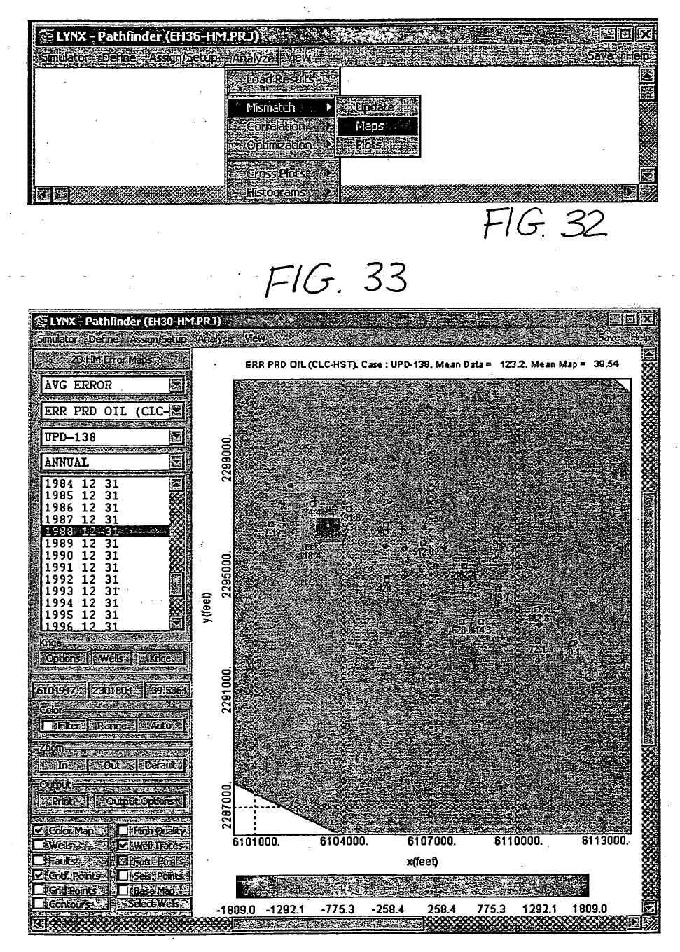

As shown in FIGS. 32-33, to generate mismatch maps, the user may select Analyze/Mismatch/Maps from a pull-down menu. Mismatch maps are graphical representations to show which well bores and/or reservoirs still have a history matching error associated therewith.

The present invention allows the user to quickly view the simulation results in the form of mismatch maps. This is a very valuable tool that can save the user a significant amount of time.

FIG. 33 uses the Average Error, rather than RMS Error. Here, the objective is to visualize the wells that over-produce and under-produce a particular fluid phase. The Average Error for reservoir pressure can also be viewed in this window, but the sparse nature of the pressure data can be misleading. With the mismatch maps, the user can display the history matching error for any history matching case that has been loaded into the database for any period of simulated time, i.e. weeks, months, and years. The user can map the history matching error for individual months, individual years, or a combination of months or years.

In the “Krige” section, the Options button provides multiple choices for standard variogram alternatives, and the Krige Wells button enables the selection of well strings that will be included in the Kriged maps. If the database contains well strings that are outside of the simulation model, it is not recommended to include them for Kriging.

Also, as shown in FIG. 33, the mismatch in annual oil production volume for the year ending Dec. 31, 1988 for a particular run is presented. The wells that over-produce are shown in red and the wells that under-produce are shown in blue. Color can be used to represent either situation and color can further be used to indicate minimal history matching error. Mismatch maps can also be used when creating well string groups. For example, the user can group the wells with severe mismatch problems and identify these problems by color differentiation. Further, in the process, the user is able to concentrate on a small group of problem wells for detailed analysis.

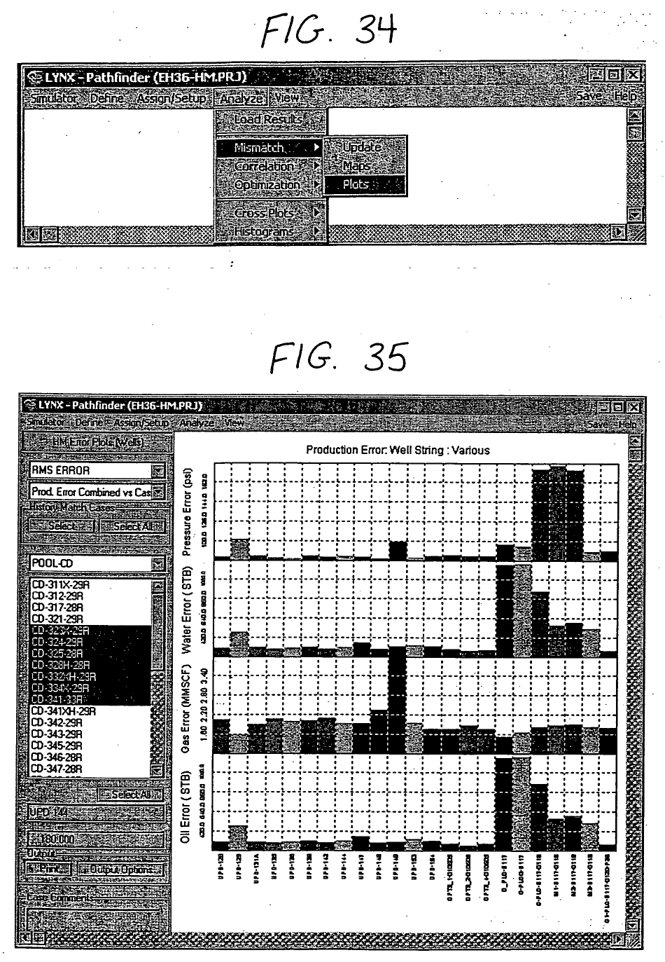

As shown in FIGS. 34-35, to generate mismatch plots, the user may select Analyze/Mismatch/Plots from a pull-down menu. The Mismatch Error plots enable the user to observe the progression of the history matching error changes in the various simulation cases. These plots can be displayed for all three error types (Average, RMS and Maximum) and for any combination of cases. The user can also select any combination of wells to observe the progression of the history matching errors.

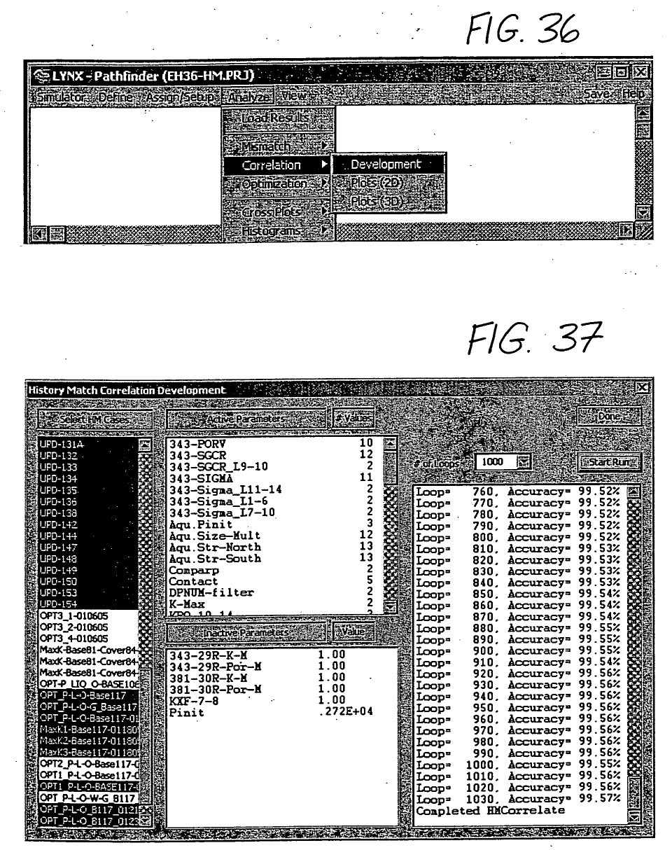

As shown in FIGS. 36-37, to begin the correlation model development and history matching improvement method and system of the present invention, the user selects Analyze/Correlation/Development from a pull-down menu. As discussed previously, the method and system of the present invention utilizes Artificial Neural Network (ANN) technology to learn the non-linear relationships among the input variables (i.e. the history matching parameters of each case) and the simulation output results (i.e. the mismatch in volumes and pressures of each case). The ANN used by the present invention has been specifically designed for this type of non-linear learning problems. The ANN has several hidden layers of different types of neurons that match the objectives of the method and system of the present invention. In one embodiment, the number of neurons is dynamically adjusted, based on the input data.

As shown in FIG. 37, in the “Correlation Development” window, the cases to be selected are shown in a list box on the left side. This list includes all cases that have been defined even ones with partial or no results. The cases with incomplete results are typically indicated for clarity. After the user selects one or more cases, the history matching parameters that vary among those cases are displayed in the “Active Parameters” area, along with the number of different values encountered. The history matching parameters that do not vary are displayed in the “Inactive Parameters” area, along with their corresponding constant values.

As shown in FIG. 37, the user typically specifies the number of Learning Loops (epochs). Initially, it is recommended that the user select a small number of loops to develop an approximate solution. After a few loops of oscillations, the learning process will start. A DOS window will appear indicating the progress bin terms of accuracy measurements and the maximum history matching error encountered during the loop. The task at hand is to maximize the accuracy and to minimize the maximum history matching error.

When the user repeats the learning process, the previous information is kept in memory and the system, and method will continue to improve the accuracy. It is recommended that the user repeat the process such that a learning accuracy of 99.80% is reached. This typically corresponds to the minimization of the maximum history matching error down to a 0.15-0.20 range. Between runs, if the number of Active HM Parameters is not changed, the present invention will keep the latest Correlation Model in memory. In this way, when the user loads results for a new case, the learning process is incremental and kept to a minimum.

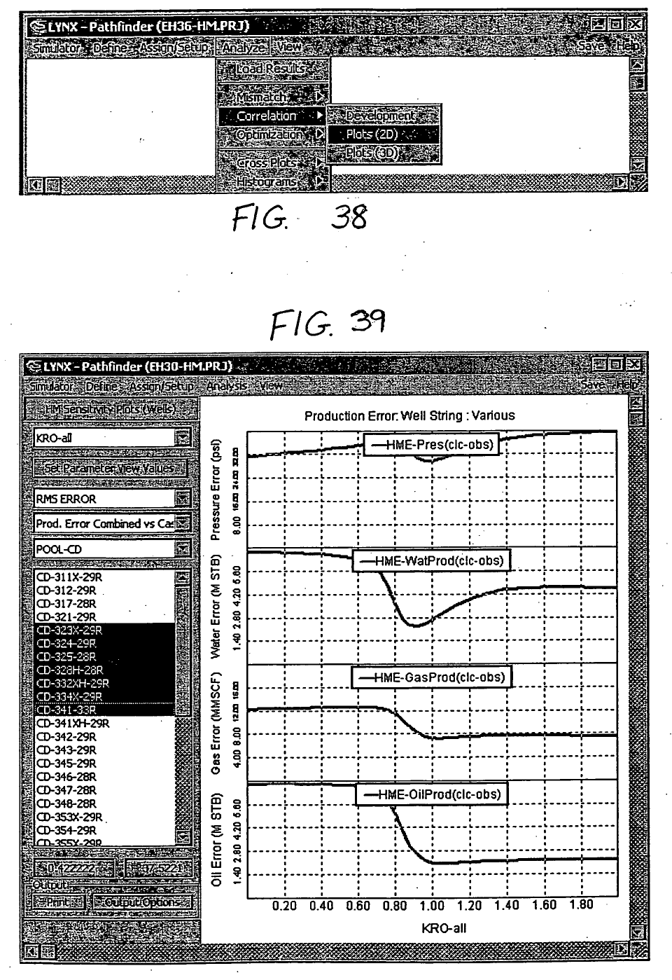

As shown in FIGS. 38-39, the user may optionally generate two-dimensional (2D) HM Sensitivity plots. To do so, the user selects Analyze/Correlation/Plots (2D) from a pull-down menu. When the above learning process is complete, the user can use this function to extract general information regarding the correlations that have been developed. While this is not a required step in the present invention, the 2D plots provide valuable information. As shown in FIG. 38, the user can view the correlations that have been developed in 2D. Further, the user can view correlations for any selected or all history matching parameters, select a particular mismatch error type, plot type (i.e. “Prod. Error Combined vs. Case” in this Figure), and a selected well string group. When the user selects a Well String Group, the well strings that belong to that group are presented in the list box below the name of the group. Using this list box, the user can view the variation of history matching error for individual well strings, or for a collection of well strings.

It is important to note that the plots show the variation of mismatch error as a function of the desired history matching parameter, using the previously specified values of other parameters. If the user modifies the values of other history matching parameters, the plots may change.

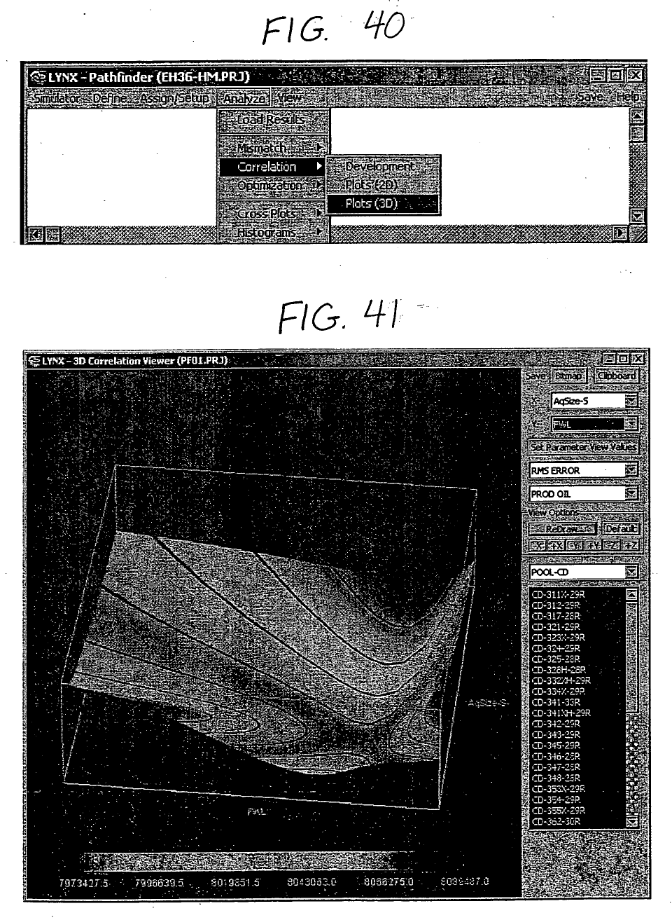

As shown in FIGS. 40-41, the user may optionally generate three-dimensional (3-D) plots. To do so, the user selects Analyze/Correlation/Plots (3D) from a pull-down menu. While this is not a required step in the present invention, the 3D plots also provide a valuable visual tool.

As shown in FIG. 41, it is possible to ascertain the variation of error (as a 3D surface and using color) as functions of two HM Parameters. Similar to the 2D Plot version, the user can select Error Type (AVE, RMS or MAX) and a combination of wells. Unlike the 2D Plot version, however, only one Plot Type (“PROD OIL” in this example) can be selected for surface generation. The coloring is set automatically and is scaled from the minimum to the maximum data available in this surface. One color may, for example, indicate smaller error and another color, for example, may indicate higher error.

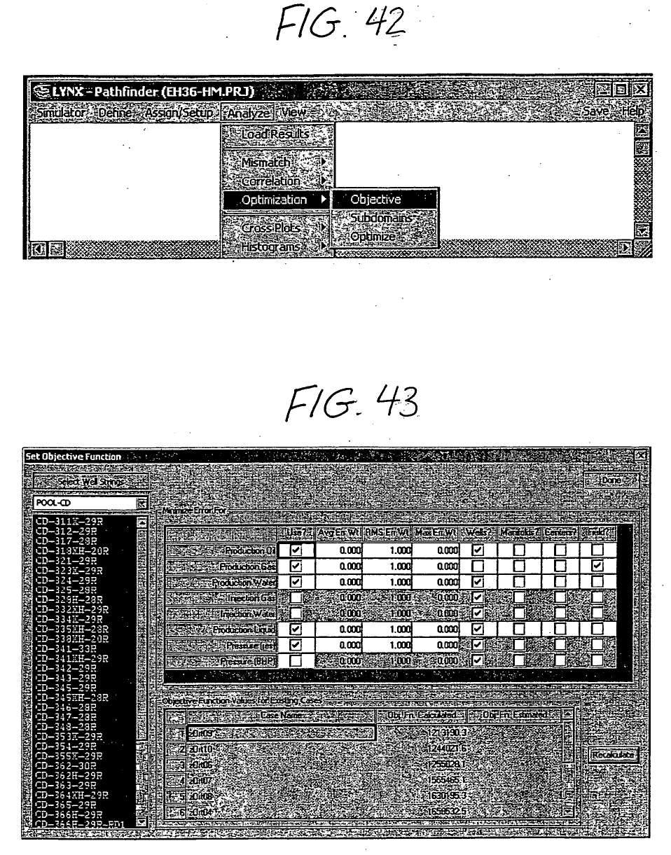

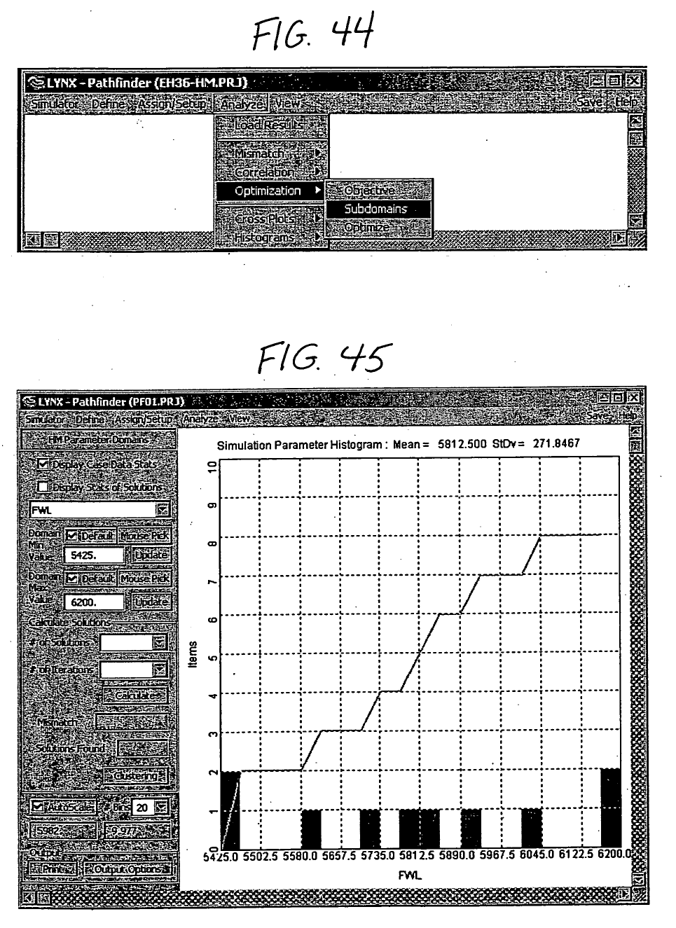

In order to estimate the next best history match run to make, the user defines the objective function that will be used for minimization of the HM error. As shown in FIGS. 42-43, the user defines the objective function by first selecting Analyze/Optimization/Objective from a pull-down menu.

The user typically defines this function such that the HM error is minimized for any number of well strings in the simulation model. Initially, it is recommended to keep the RMS Error Weight factors around 1.0. The RMS Error Weight factors can be modified later depending on the problem type that is being simulated.

As shown in FIGS. 44-46, the present invention also provides the user with the option to provide subdomain analysis and optimization for any one of the history matching parameters. To do so, the user selects Analyze/Optimization/Subdomains from a pull-down menu. By default, in one embodiment, the search for the optimized solution that minimizes the specified objective function is carried out for the full domain of history matching. For example, if a history matching parameter (such as “PermMult”) is defined to have a domain that ranges from 0.0 to 2.0, the search for the optimized solution is constrained to the full domain. As the user learns more about the impact of such a parameter, the user may limit the optimized solution to a narrower sub-domain, such as from 0.5 to 0.9.

The subdomain function can be used for different purposes. For example, the user can view the variation of the history matching parameters in the existing cases. In one embodiment, the variation of the history matching parameters is displayed in the form of a histogram and the Cumulative Distribution Function (CDF) curves will be displayed. One main purpose of the subdomain analysis facility is to analyze the history matching parameter histograms for multiple acceptable solutions.

In one embodiment, the subdomain analysis is carried out by using Monte-Carlo iterations. First, the user selects the desired number of solution. Typically 50 or 100 solutions should suffice. Next, the user selects the desired number of number of Monte-Carlo iterations. More iterations means that the number of solutions retained will be closer to the global minimum. In the early stages of the history matching exercise, it is recommended that the user select a small number of iterations. As more simulation results are introduced and as the Correlation Model becomes more accurate, the user can increase the number of iterations to seek solutions closer to the global minimum.

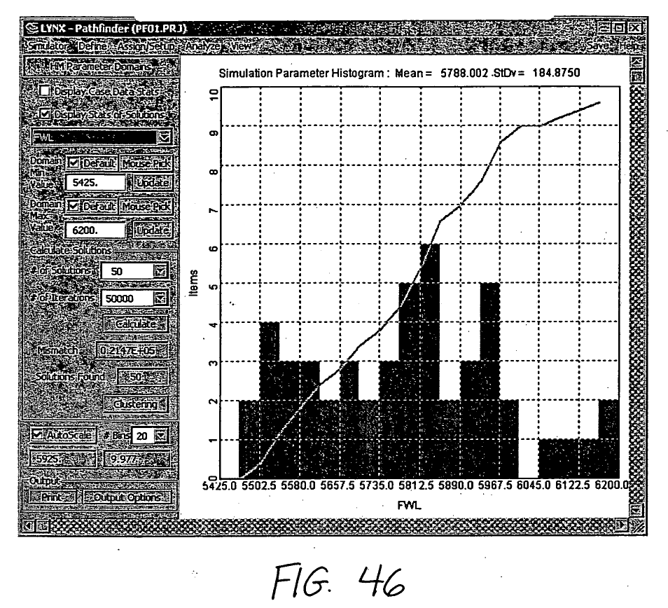

Next, the method and systems activates a Monte Carlo technique. The method and system will retain the best number of solutions defined with lowest Objective Function among the total iterations. The results can be displayed as a histogram and as a Cumulative Distribution Function (CDF) curve. In the plot shown in FIG. 46, a histogram is displayed for a history matching parameter called “FWL.” This plot indicates that the minimum value should be increased to 5460. Given this plot, the user could narrow the search domain for this history matching parameter by modifying the minimum value in the numeric field at the upper left of the screen. Reduction in the domain of the history matching parameters will narrow the search for the optimized solution. It also applies to all the Monte-Carlo simulation runs performed thereafter. Typically, if the user enters a value beyond the original full domain, the method and system will revert to the last values that were specified.

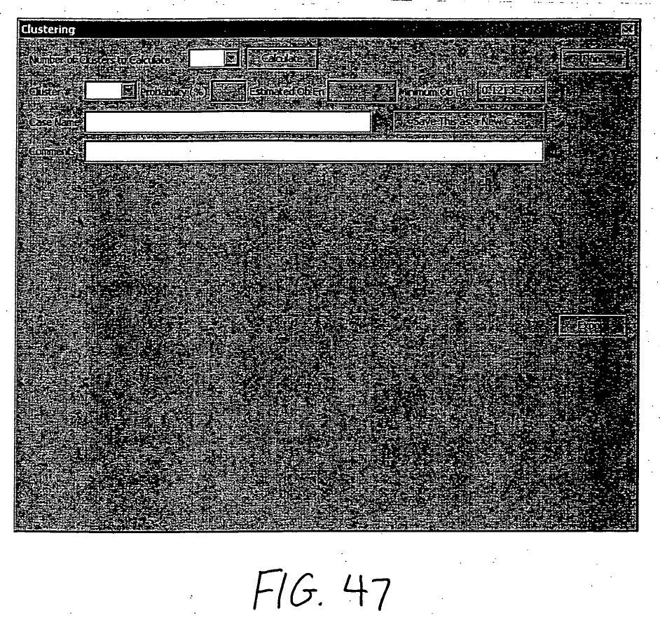

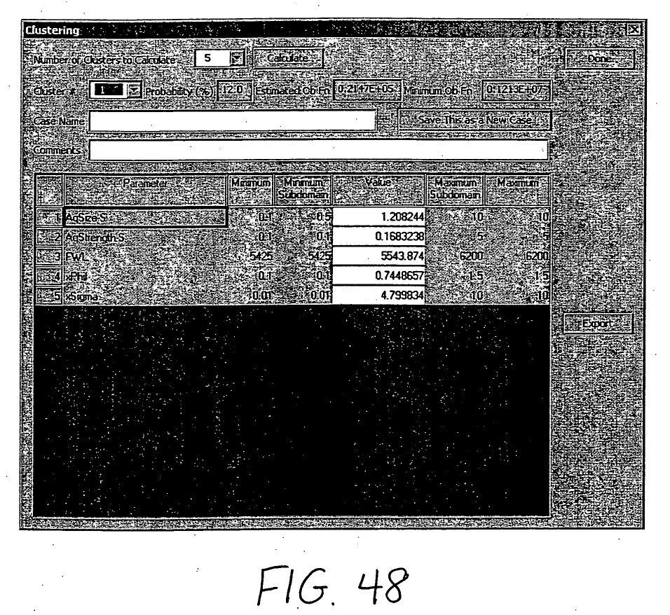

As shown in FIGS. 47-48, the user may optionally cluster multiple solutions. To do so, first, the user selects Clustering from a pull-down menu. Thereafter, to cluster the selected solutions that were generated through the Monte-Carlo technique, the user selects the number of clusters. Upon clustering of the selected solutions, the user can select the cluster number to view, and the remaining portion of the dialog box will be filled as shown in FIG. 45.

As displayed in FIG. 48, certain information is presented for each cluster. In this example, Cluster #1 contains 6 solutions (out of 50 selected in the Monte-Carlo simulation). Thus, the probability of this cluster is 12.0%. Additionally, the set of history matching parameters for the best solution in this cluster is presented. For comparison, the estimated objective function value of the cluster (using the correlation model) is displayed together with the objective function value of the best existing case. In one embodiment, the user will have to externally prepare the data set for these new simulation cases using the defined set of history matching parameters.

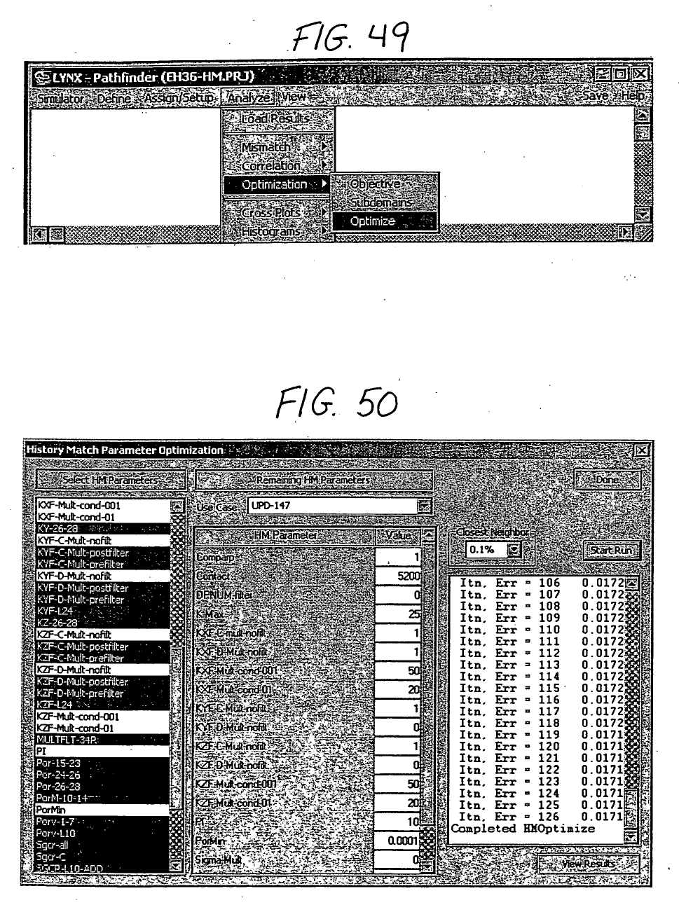

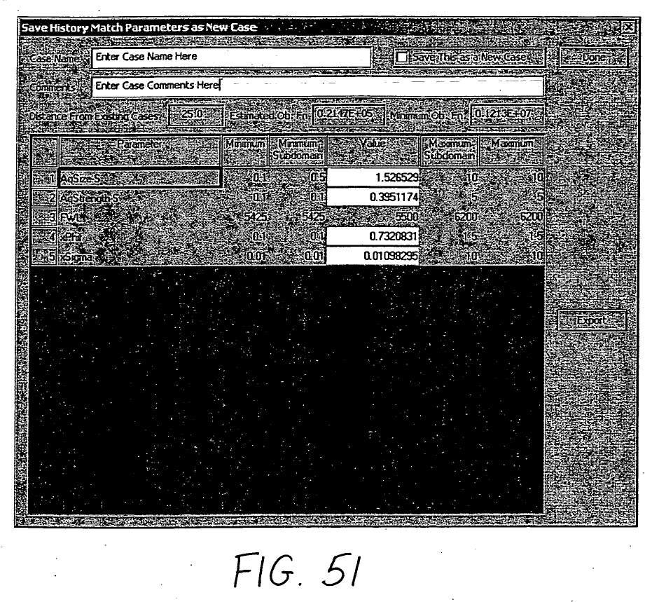

As shown in FIGS. 49-50, to find the optimized solution, the user selects Analyze/Optimization/Optimize from a pull-down menu. In this function, the method evaluates the history matching error correlation model to determine the history matching parameter values that minimize the specified objective function. As shown in FIG. 50, the user can set values to use in the optimization process. The list box at the upper left displays the set of history matching parameters that were used to develop the history matching error results. Using standard Windows selection methods, for example, the user can select a subset of the history matching parameters. The selected parameters may be highlighted in a list box, for example. Non-selected parameters will be unhighlighted, and will also be listed in the Remaining HM Parameter list box. The user can change the values of these history matching parameters manually, or the user can select them to match a specific case.

The value in the “Closest Neighbor” field (default=0.1%) dictates the minimum Euclidian distance required. If this value is too large, the optimized solution will have to be a significant distance away from the existing solutions (Cases) in the database.

A variant of Genetic Algorithms is used to solve for the global minimum of the desired objective function. Finding the optimized solution requires multiple generations (iterations), and the evolution of the best resulting genetic algorithm (minimal history matching error) is displayed as output. Upon convergence, the best solution is stored in a suitable memory device. On the rare occasion when the global minimum is not found, the user can restart the process. A reduction in the reported minimal history matching error will indicate a better solution.

As shown in FIG. 51, when the Genetic Algorithm search for the global minimum has completed, the best solution is saved in the database. The user may also create a text file that contains the history matching parameters for all the saved cases.

FIG. 14 shows the interrelationship between the activities performed above. As shown, first a base simulation case is created 200, thereafter the history matching parameters may be defined 202, additional history match runs (cases) are created after selecting the history matching parameters for perturbation 204, using a neural network, a correlation model is developed between the history matching parameters and error (between historical and simulated results) 206. Thereafter, an objective function is defined 208. The user defines the objective function that will be used for minimization of the HM error. The objective function iteratively varies a values of the selected history matching parameters to produce an optimized case 210 or a set of optimized cases (clusters) 212. The optimized case or cases include a set of history matching parameters that minimize the objective function. Using the now optimized set of history matching parameters, the correlation model can be updated 214 and the objective function refined 216 to provide further improvement in the quality of the history match 218. The Final HM case 220 represents the final best case determined in the iterative optimization process. The Multiple Best HM cases 222 represent the final multiple optimized cases (clusters) in the iterative optimization process.

While an effort has been made to describe various alternatives to the preferred embodiment, other alternatives will readily come to mind to those skilled in the art. Therefore, it should be understood that the invention might be embodied in other specific forms without departing from the spirit or central characteristics thereof. Present examples and embodiments, therefore, are to be considered in all respects as illustrative and not restrictive, and the invention

is not intended to be limited to the details given herein.

What is claimed is:

1. A method for accelerating and improving the history matching of a reservoir simulation model, comprising:
a) receiving historical performance data for at least one of a well bore and a reservoir;
b) constructing a theoretical production output model for said at least one of a well bore and a reservoir using said received results;
c) calculating a history matching error between said theoretical production output model and said historical results for said at least one of a well bore and a reservoir;
d) receiving a plurality of reservoir parameters corresponding to properties of said at least one of a well bore and a reservoir;
e) using a neural network, providing a correlation between a selected set of said parameters and said history matching error; and
f) iteratively varying at least one of a selection and a value of said parameters in said neural network to provide at least one set of reservoir parameters having a value that provides a minimum for said history matching error.

2. The method of claim 1, wherein said iteratively changing further comprises providing a plurality of sets of reservoir parameters that provide a minimum for said history matching error.

3. The method of claim 1, further comprising training said neural network using said historical data from said receiving (a) and said history matching error from said calculating (c).

4. The method of claim 1, further comprising graphically representing the correlation between said selected parameters and said calculated history matching error from said calculating (c).

5. The method of claim 4, wherein the graphical representation includes a plurality of different values for said selected parameters.

6. The method of claim 1, further comprising receiving a domain for each of said reservoir parameters, and iteratively varying said value of at least one of said parameters within the domain.

7. The method of claim 7, further comprising receiving a subdomain for each of said reservoir parameters, and iteratively varying said value of at least one of said parameters within the subdomain.

8. The method of claim 1, wherein said at least one set of reservoir parameters that provides a minimum for said history matching error defines a simulation model, and using said simulation model to predict a future performance of said at least one of a well bore and a reservoir.

9. The method of claim 1, wherein said iteratively varying comprises iterating at least one of a selection and a value of said at least about 20 parameters in said neural network substantially simultaneously.

10. A system for accelerating and improving the history matching of a reservoir simulation model, comprising:
a) means for receiving historical performance data for at least one of a well bore and a reservoir;
b) means for constructing a theoretical production output model for said at least one of a well bore and a reservoir using said received results;
c) means for calculating a history matching error between said theoretical production output model and said historical results for said at least one of a well bore and a reservoir;
d) means for receiving a plurality of reservoir parameters corresponding to properties of said at least one of a well bore and a reservoir;
e) using a neural network, providing a correlation between a selected set of said parameters and said history matching error; and
f) iteratively varying at least one of a selection and a value of said parameters in said neural network to provide at least one set of reservoir parameters having a value that provides a minimum for said history matching error.

11. A method for predicting the recovery of fluids in a reservoir using a computer comprising:
a) receiving historical performance data for at least one of an individual well bore and a reservoir;
b) constructing a theoretical production output model for said at least one of a well bore and a reservoir using said received data;
c) calculating a history matching error between said theoretical production output model and said historical production output data for said at least one of a well bore and a reservoir;
d) modifying a parameter of the received data and redoing steps (b) and (c) if the calculated value of said history matching error is different from a predetermined value;
e) displaying said calculated history matching error as a graphical representation in at least one of a plot and a map.
f) predicting a future production output for said at least one of a well bore and a reservoir when the calculated value of the history matching error is equal to or less than the predetermined value.

12. The system of claim 11, wherein said received data comprises information related to at least one of oil production, gas production, gas/oil ratio, water production, water injection, gas injection, pressure, permeability, porosity, and a production performance curve.

13. A system for predicting the recovery of fluids in a reservoir on a computer comprising means for receiving data for at least one of a well bore and a reservoir;
a) means for receiving historical performance data for at least one of an individual well bore and a reservoir;
b) means for constructing a theoretical production output model for said at least one of a well bore and a reservoir using said received data;
c) means for calculating a history matching error between said theoretical production output model and said historical production output data for said at least one of a well bore and a reservoir;
d) means for modifying a parameter of the received data and redoing steps (b) and (c) if the calculated value of said history matching error is different from a predetermined value;
e) means for displaying said calculated history matching error as a graphical representation in at least one of a plot and a map.
f) means for predicting a future production output for said at least one of a well bore and a reservoir when the calculated value of the history matching error is equal to or less than the predetermined value.

14. The system of claim 13, wherein said received data comprises information related to at least one of oil production, gas production, gas/oil ratio, water production, water injection, gas injection, pressure, permeability, porosity, and a production performance curve.
